(19) United States
(12) Patent Application Publication
(10) Pub. No.: US 2026/0011467 A1
(43) Pub. Date: Jan. 8, 2026

(54) ACTIVE SIGNAL EMISSION ELECTRICALLY CONDUCTIVE PIPE

(71) Applicants: Jie Huang, Rolla, MO (US); Rex E. Gerald, II, Willow Springs, IL (US); Abhishek Prakash Hungund, San Diego, CA (US); Bohong Zhang, Rolla, MO (US); Homayoon Soleimani Dinani, Rolla, MO (US); Ryan O'Malley, Rolla, MO (US); Kelsey Vancil, Bourbon, MO (US); Michael Lee Davis, II, Rolla, MO (US); Thomas M. Spudich, Lake Saint Louis, MO (US)

(72) Inventors: Jie Huang, Rolla, MO (US); Rex E. Gerald, II, Willow Springs, IL (US); Abhishek Prakash Hungund, San Diego, CA (US); Bohong Zhang, Rolla, MO (US); Homayoon Soleimani Dinani, Rolla, MO (US); Ryan O'Malley, Rolla, MO (US); Kelsey Vancil, Bourbon, MO (US); Michael Lee Davis, II, Rolla, MO (US); Thomas M. Spudich, Lake Saint Louis, MO (US)

(73) Assignee: The Curators of the University of Missouri, Columbia, MO (US)

(21) Appl. No.: 18/762,103

(22) Filed: Jul. 2, 2024

(51) Int. Cl. H01B 5/14; H01B 1/22; H01Q 9/28

(52) U.S. Cl. CPC H01B 5/14; H01B 1/22; H01Q 9/28

(57) ABSTRACT

An electrically conductive pipe comprises a tube structure having an electrically insulative wall with an interior surface and an exterior surface. Moreover, the electrically conductive pipe comprises a plurality of laser-scribed graphene conductive traces integrated at least partially into the electrically insulative wall. The laser-scribed graphene conductive traces are integrated into the tube structure such that they are integrated at least one of on the interior surface of the electrically insulative wall, on the exterior surface of the electrically insulative wall, and between the interior surface and exterior surface within the electrically insulative wall. The laser-scribed graphene conductive traces are formed onto or within the tube structure by irradiating the tube structure in a predefined trace pattern with a laser to induce reactions that convert the material of the tube structure into the laser-scribed graphene conductive traces. The electrically conductive pipe is configured for a wide array of applications.

### BACKGROUND

Polyvinyl Chloride pipe, otherwise known as PVC pipe, is a type of plastic piping extensively utilized in various applications due to its durability, versatility, and cost-effectiveness. Made from a combination of plastic and vinyl, PVC pipes have become a reliable choice for both residential and industrial applications. For example, one of the primary uses of PVC pipes is in water transportation, where such pipes are employed for the conveyance of drinking water, wastewater, and for irrigation systems. The corrosion resistance of PVC pipes makes them particularly suitable for water applications, as opposed to metal pipes that are prone to corrode over time. Additionally, PVC pipes play a significant role in the building and construction sector, where they are utilized for plumbing systems, electrical conduit, and for Heating Ventilation and Air Conditioning (HVAC) applications, offering an efficient solution for the delivery and removal of air and fluids. PVC pipes are generally fire-resistant and light-weight, thereby making them the preferred choice in construction projects, particularly for temporary setups and modular buildings.

With advances in manufacturing techniques, the adaptability and range of applications for PVC pipes continue to grow, ensuring their prominence in various sectors for years to come. Accordingly, the demand for PVC pipes in the market is significant and continues to grow. For example, the Plastic (PVC) Pipes Market is projected to reach a value of US$63.78 Billion by the end of 2033. This demonstrates a considerable market value and indicates a steady demand for PVC pipes in various sectors. Additionally, the PVC Pipes Market is expected to grow at a Compound Annual Growth Rate (CAGR) of 4.3%, suggesting an ongoing positive trend in its market demand.

### SUMMARY

Aspects of the present disclosure permit electrically conductive pipes, methods for forming electrically conductive pipes, and manufacturing systems for forming electrically conductive pipes, particularly from PVC.

In one aspect, an electrically conductive pipe comprises a tube structure comprising an electrically insulative wall having an interior surface and an exterior surface spaced apart by a thickness of the electrically insulative wall. The tube structure comprises a first end portion and a second end portion spaced apart longitudinally along a length thereof. A plurality of laser-scribed graphene conductive traces is integrated at least partially into the electrically insulative wall of the tube structure.

In another aspect, a manufacturing method for manufacturing an electrically conductive pipe, the electrically conductive pipe comprising an interior surface and an exterior surface spaced apart by a thickness of the electrically conductive pipe, comprises forming a tube structure from a plastic precursor material. A laser is positioned proximate the tube structure in at least one of an embedding position, interior surface position and exterior surface position. The tube structure is irradiated in a predefined trace pattern with the laser to induce precursor material reactions that convert the plastic precursor material into one or more laser-scribed graphene conductive traces for forming the electrically conductive pipe. The laser-scribed graphene conductive traces are at least one of embedded within the electrically conductive pipe, on the interior surface of the electrically conductive pipe, and on the exterior surface of the electrically conductive pipe.

In yet another aspect, a pipe manufacturing system for manufacturing an electrically conductive pipe comprises a pipe forming system configured to form a plastic precursor material into a tube structure comprising an electrically insulative wall having an interior surface and an exterior surface spaced apart by a pipe thickness. A laser scribing system is configured to irradiate the tube structure in a predefined trace pattern to induce precursor material reactions that convert the plastic precursor material into one or more laser-scribed graphene conductive traces that are at least one of embedded within the electrically insulative wall of the tube structure, on the interior surface of the electrically insulative wall of the tube structure, and on the exterior surface of the electrically insulative wall of the tube structure. An electroplating system is configured to apply a layer of electrodeposited material to the one or more laser-scribed graphene conductive traces. An insulating material coating system is configured to apply insulating material to the one or more laser-scribed graphene conductive traces.

Other objects and features will be in part apparent and in part pointed out hereinafter.

### BRIEF DESCRIPTION OF THE DRAWINGS

FIG. 1 is a schematic illustration of an electrically conductive pipe with laser-scribed graphene conductive traces on an exterior surface of the electrically conductive pipe, according to an embodiment.

FIG. 2 is a cross-section taken in the plane of A-A of FIG. 1, according to an embodiment.

FIG. 3 is a schematic illustration of an electrically conductive pipe with laser-scribed graphene conductive traces on an interior surface of the electrically conductive pipe, according to an embodiment.

FIG. 4 is a cross-section taken in the plane of B-B of FIG. 3, according to an embodiment.

FIG. 5A is a cross-section of an electrically conductive pipe with laser-scribed graphene conductive traces embedded within a pipe wall of the electrically conductive pipe, according to an embodiment.

FIG. 5B is a cross-section of an electrically conductive pipe with laser-scribed graphene conductive traces embedded within a pipe wall of the electrically conductive pipe, according to an embodiment.

FIG. 6 is a schematic illustration of an electrically conductive pipe comprising laser-scribed graphene conductive traces configured for remotely charging electronic devices, according to an embodiment.

FIG. 7 is an enlarged perspective of an electronic circuit of detail C from FIG. 6, according to an embodiment.

FIG. 8 is a schematic illustration of an electrically conductive pipe comprising laser-scribed graphene conductive traces configured as a coil antenna for frequency transmission, according to an embodiment.

FIG. 9 is a schematic illustration of an electrically conductive pipe comprising laser-scribed graphene conductive traces configured as a dipole antenna for frequency transmission, according to an embodiment.

FIG. 10 is a schematic illustration of laser-scribed graphene conductive traces being formed on an exterior surface of an electrically conductive pipe, according to an embodiment.

FIG. 11 is a schematic illustration of laser-scribed graphene conductive traces being formed on an interior surface of an electrically conductive pipe, according to an embodiment.

FIG. 12 is a schematic illustration of laser-scribed graphene conductive traces being embedded within a pipe wall of an electrically conductive pipe, according to an embodiment.

FIG. 13 is a schematic illustration of a manufacturing system for manufacturing an electrically conductive pipe, according to an embodiment.

Corresponding reference characters indicate corresponding parts throughout the drawings.

### DETAILED DESCRIPTION

The present disclosure generally relates to electrically conductive pipes, methods for forming the electrically conductive pipes, and manufacturing systems for executing the methods thereon. Particularly, the present disclosure focuses on the modification of pipes formed of carbon-containing materials, using laser technology to create electrically conductive and functionalized pipes. For example, the present disclosure employs laser-scribing to thermo-chemically convert regions of the plastic pipes into electrically conductive graphene-based traces, enabling conduction, communication, and sensing capabilities for diverse applications, as will be explained in greater detail below.

Products, methods, and systems in accordance with the present disclosure, provide a significant leap and enhancement in pipe utility, integrating technological advancements directly into the pipe's structure, thereby revolutionizing industries reliant on piping systems. The combination of plastic pipes (or pipes formed of carbon-containing materials) durability, and graphene's multi-faceted functionality promises a revolution in pipeline utility. Moreover, the cost-savings are substantial. Electrically conductive pipes obviate the need for separate electrical conduits, merging utility and communication needs into a singular (often buried) infrastructure. Additionally, the conductive traces may be configured as high-frequency, high-voltage traces that may eventually replace portions of the power transmission grid, presenting a streamlined, dual-purpose integrated solution.

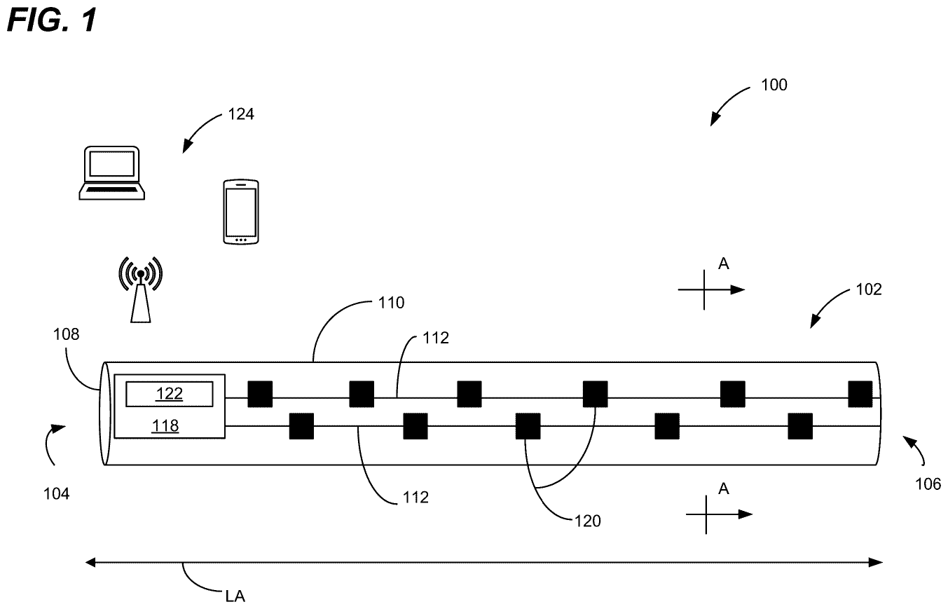

Referring now to FIG. 1, an electrically conductive pipe in accordance with the present disclosure is generally indicated at reference number 100. The electrically conductive pipe 100 broadly comprises a tube structure 102 with a first end portion 104 and a second end portion 106 spaced apart longitudinally along a length of the tube structure. Moreover, the tube structure 102 comprises an electrically insulative wall having an interior surface 108 and an exterior surface 110 spaced apart by a thickness of the electrically insulative wall. The electrically conductive pipe 100 further comprises a plurality of laser-scribed graphene conductive traces 112 integrated at least partially into the electrically insulative wall of the tube structure. In the illustrated embodiment, the laser-scribed graphene conductive traces 112 are shown extending along the length of the tube structure between the first end portion 104 and the second end portion 106, however it will be apparent that other configurations of the laser-scribed graphene conductive traces are possible without departing from the scope of the present disclosure.

The tube structure 102 is formed of a carbon-containing material. In an exemplary embodiment, the tube structure is formed of a plastic precursor material such a non-conductive polyvinyl chloride (PVC). PVC generally comprises halo hydrocarbons, primarily chlorinated hydrocarbons, that when subjected to intense conditions produced by a laser, undergo de-chlorination and a restructuring process. This process involves the breaking of carbon-chlorine bonds and the reorganization and rebonding of carbon atoms. The resulting material from this laser-induced transformation exhibits properties akin to carbon-based compounds such as carbon black, graphite, graphene, and graphene oxide. Carbon black is formed as a result of incomplete combustion or thermal decomposition of hydrocarbons. It consists of small carbon particles with a structure that is partially graphitic. Graphite, on the other hand, is a crystalline form of carbon with layers of graphene stacked together. Graphene itself is a single layer of carbon atoms arranged in a hexagonal lattice, known for its remarkable electrical conductivity, strength, and flexibility. Graphene oxide is a derivative of graphene and is the product of graphene reacting with oxygen; it features various oxygen-containing groups, which makes it dispersible in water and other solvents.

As a result of subjecting the tube structure 102 (e.g., a PVC pipe or pipe being formed of other carbon-containing materials) to the laser, the laser-scribed graphene conductive traces 112 are formed. The trace formation endows the otherwise non-conductive carbon-containing material (e.g., PVC) with electrical conductivity, thereby broadening its potential applications, especially in areas requiring conductive materials. The laser-scribed graphene conductive traces 112 may be formed in any pattern suitable for the intended application of the electrically conductive pipe. The inclusion of the laser-scribed graphene conductive traces 112 on the tube structure 102 demonstrates an innovative approach to material modification, leveraging advanced laser technology to imbue traditional materials with new functionalities. For example, the laser-scribed graphene conductive traces 112 configure the tube structure 102 as the electrically conductive pipe 100, thereby serving as a conduit for electricity.

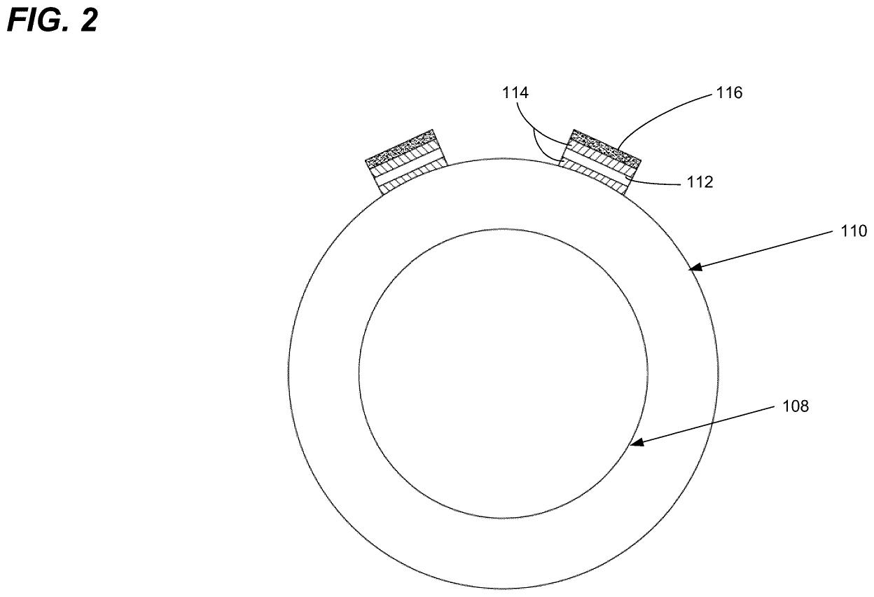

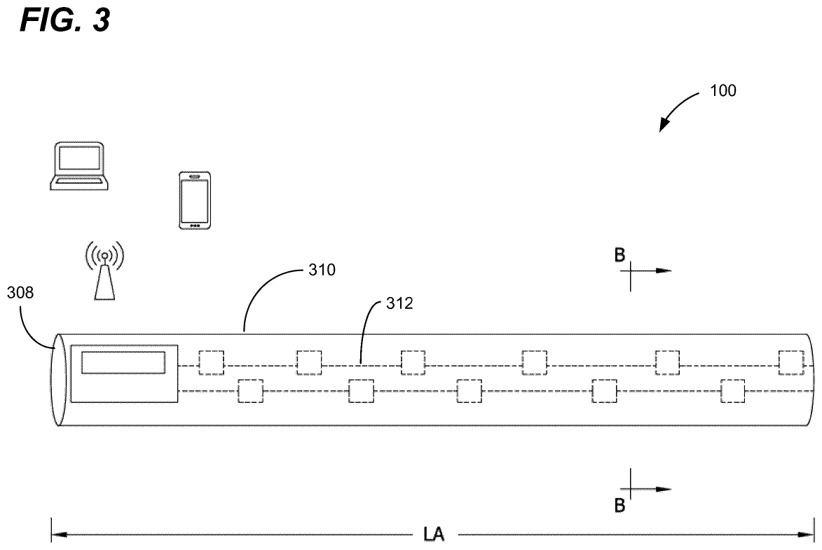

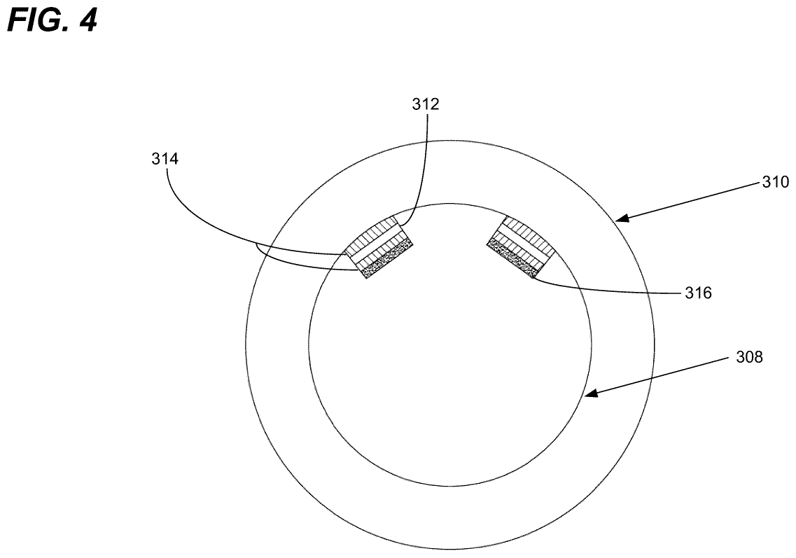

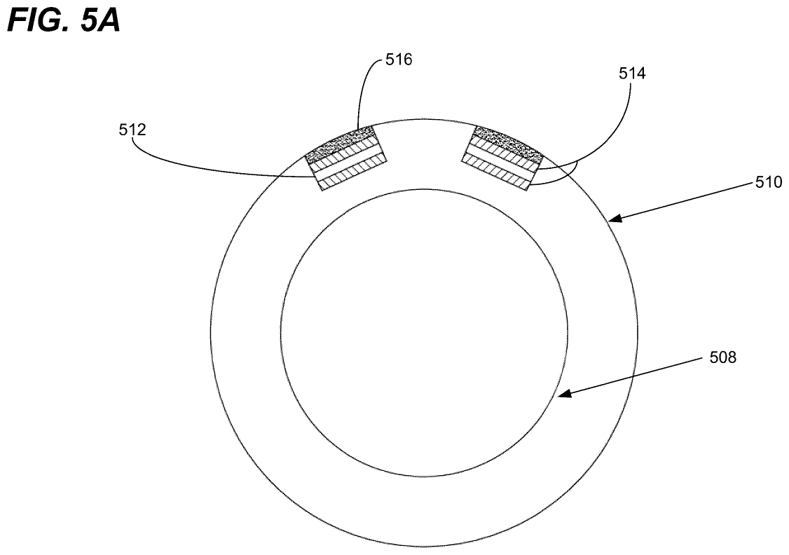

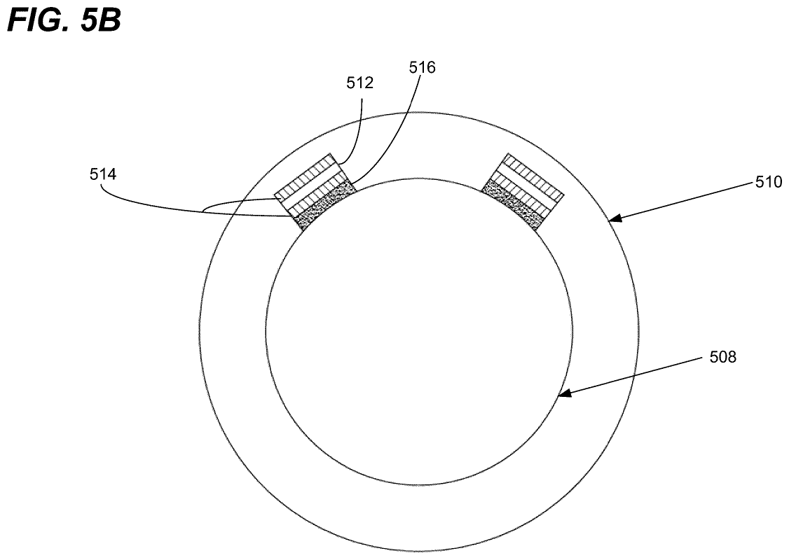

The laser-scribed graphene conductive traces 112 are integrated into the tube structure 102 such that the laser-scribed graphene conductive traces are integrated at least one of on the interior surface 108 of the electrically insulative wall of the tube structure, on the exterior surface 110 of the electrically insulative wall of the tube structure, and between the interior surface and exterior surface within the electrically insulative wall of the tube structure. FIGS. 1-2 show the laser-scribed graphene conductive traces 112 integrated onto the exterior surface 110. FIGS. 3-4 show the laser-scribed graphene conductive traces 312 integrated onto the interior surface 308. FIGS. 5A and 5B show the laser-scribed graphene conductive traces 512 embedded within the electrically insulative wall. Particularly, 5A shows the laser-scribed graphene conductive traces 512 embedded within the electrically insulative wall and biased towards the exterior surface 510. 5B shows the laser-scribed graphene conductive traces 512 embedded within the electrically insulative wall and biased towards the interior surface 508. It will be apparent to one of ordinary skill in the art, that the laser-scribed graphene conductive traces 512 may be embedded within the electrically insulative wall in positions not shown in FIGS. 5A and 5B, without departing from the scope of the present disclosure.

In any of the embodiments discussed above, the laser-scribed graphene conductive traces 112 may be configured to include at least one of a protective coating 114 and an insulating material layer 116. The protective coating 114 is positioned around the laser-scribed graphene conductive trace 112 to ensure longevity and reliability of the laser-scribed graphene conductive traces within harsh environments of typical pipelines. In the case that the laser-scribed graphene conductive traces 112 are embedded within the electrically insulative pipe wall, the material of the electrically insulative pipe wall acts as the protective coating 114 and insulating material layer 116. Advantageously, this embodiment eliminates the need for external protective coatings such as paints or lacquers. Moreover, in a plastic pipe extrusion manufacturing facility, the introduction of paint and lacquer hydrocarbon solvents presents a flammability liability that embedded laser-scribing avoids. Furthermore, internal embedding shields the laser-scribed graphene conductive traces 112 from direct contact with external elements and fluids that may be electrically conductive, thereby enhancing durability and reducing maintenance needs.

Referring back to FIG. 1, one or more power sources 118 are electrically connected to the laser-scribed graphene conductive traces 112. In the illustrated embodiment, the power source 118 is proximate at least one of the first and second end portions 104,106 of the tube structure 102. Moreover, the power source 118 is mounted at least one of external and internal to the tube structure 102. The power source 118 acts as a conduit to activate and power the laser-scribed graphene conductive traces 112. In an exemplary embodiment, the power source 118 contains essential electronic components such as AC and DC power supplies, capable of delivering voltages typical for industrial applications. For example, the power source 118 is configured to deliver voltages ranging from 1V DC for low-power sensors up to 240V AC for higher-powered devices like lights and motors. In one embodiment, the power source 118 is configured to house radiofrequency power amplifiers and receivers with the capability to boost signal strength for the antenna systems scribed on the pipe (discussed in greater detail below), operating at standard RF communication bands (e.g., 2.4 GHz for Wi-Fi). This integration facilitates a variety of sensing and telemetry functions, enabling real-time data acquisition. The power source 118 is designed for modularity and ease of connection, allowing for quick interfacing with various devices necessary for comprehensive environmental and operational surveillance. In another embodiment, the power source 118 comprises batteries for remote long-term operation of other electronic devices used in conjunction with the electrically conductive pipe 100.

In an exemplary embodiment, one or more monitoring devices 120 are electrically connected to the laser-scribed graphene conductive traces 112 such that the one or more monitoring devices are configured to monitor at least one of one or more electrical properties of the laser-scribed graphene conductive traces and one or more surrounding conditions of the electrically conductive pipe 100. For example, the one or more monitoring devices 120 comprise various types of sensors such as graphene-based sensors to leverage sensitivity and electrical properties for monitoring a range of parameters. Moreover, the one or more monitoring devices 120 are configured to monitor at least one of the one or more electrical properties of the laser-scribed graphene conductive traces 112 and the one or more surrounding conditions of the electrically conductive pipe 100 for at least one of leak detection of the electrically conductive pipe, structural health monitoring of the electrically conductive pipe, temperature monitoring of the electrically conductive pipe, anti-fouling of the electrically conductive pipe, heating of the electrically conductive pipe, and wireless activity of the electrically conductive pipe, as will be described in greater detail below.

In another embodiment, a wireless communication module 122 is electrically connected to at least one of the monitoring devices 120, laser-scribed graphene conductive traces 112, and power source 118. It is contemplated that the wireless communication module 122 may also be integrated into the power source 118. The wireless communication module 122 is configured to communicate one or more conditions of the electrically conductive pipe 100 based on at least one of the electrical properties of the laser-scribed graphene conductive traces 112 and the surrounding conditions, to one or more remote devices 124.

In yet another embodiment, the tube structure 102 comprises an extruded PVC pipe having a circular cross section, During the extrusion process, a bead of polymer plastic (e.g., polyimide) is co-extruded on the outer surface of tube 102. The interior portion of the polymer plastic bead is more easily converted to graphene using a laser, compared to the PVC pipe plastic. A protective coating is applied to the top of the bead during the pipe extrusion and bead formation process. All processes proceed simultaneously. In FIG. 1, the bead of polymer plastic material is selected from an array of polymers based on ease of conversion to graphene by laser irradiation, while the pipe material (e.g., PVC) is primarily selected based on robust mechanical and structural purposes. In contradistinction, FIG. 5A illustrates the case where the PVC polymer plastic pipe material is directly converted to graphene but at a higher energy cost and with relatively greater difficulty. Thus, FIG. 1 illustrates a process that is advantageous for aspects of the present disclosure because it selects a polymer plastic (e.g., polyimide) for the facile formation of graphene from laser irradiation and independently selects a (different) polymer plastic (e.g., PVC) for the facile formation of a plastic pipe for material transport or other structural-based purposes.

The present disclosure is useful for a wide variety of applications, as it transforms widely used piping systems into sensing devices capable of monitoring various conditions of the pipe system and surrounding environment. More specifically, all applications that employ plastic pipes and associated industries, where the plastic pipes are used, are impacted by the present disclosure. Metal pipe limitations and problems currently cause major pain points in private and commercial sectors that can be alleviated by imparting electrically conductive traces onto and into ubiquitous plastic pipes. Consideration is included for sensing applications, pipe locating applications, infrastructure health monitoring, seismic sensing, flooding sensing, environmental monitoring, vibration sensing from cars and trucks above ground, and others, as will be described in greater detail below.

The present disclosure is configured to accommodate several plastic pipe types. For example, various types of non-conductive plastic pipes, primarily composed of hydrocarbon polymers, can be converted to conductive graphene through the application of high-power pulsed laser beams. This process involves the localized heating and restructuring of the carbon atoms in the polymer matrix into graphene. Pipes made of glass and other materials that are coated with a polymer coating are also suitable for the present disclosure. Polymer coatings as thin as a few microns and as thick as several millimeters or more can be laser-scribed to yield conductive graphene traces. Some common types of plastic pipes that are suitable for use with the present disclosure include:
Polyvinyl Chloride (PVC)—PVC is widely used in residential and commercial plumbing for its durability and chemical resistance.
Polyethylene (PE)—This includes both high-density polyethylene (HDPE) and low-density polyethylene (LDPE), commonly used in water supply systems and agricultural irrigation.
Polypropylene (PP)—Used in hot and cold-water applications.
Polystyrene (PS)—Often used in the construction industry for insulated piping.
Polybutylene (PB)—Previously popular for plumbing systems.
Acrylonitrile Butadiene Styrene (ABS)—Used in waste drainage.

The accompanying tables detail the specifications of common piping systems, including diameter ranges from approximately 6 to 36 inches, with materials like PVC, HDPE, and cross-linkable polyethylene featured. The specific sizes, manufacturers, vendors, and cost data for these plastic pipe types are not provided, so generic categories are used.

TABLE 1
Methane Gas Transport and Municipal Water Works

| | Size | | | | | Potential |
|---|---|---|---|---|---|---|
| Type of Pipe | Range | Application | Material | Industries | Limitations | Improvements |
| Polyethylene | Varies | Methane | Polyethylene | Energy, | Difficult to | Enhanced leak |
| Pipes | | Gas | | Water | locate, | detection, |
| | | Transport, | | Utilities | prone to | infrastructure |
| | | Municipal | | | leaks, | monitoring, |
| | | Water | | | limited | easier location |
| | | Supply | | | monitoring | |

TABLE 2
Other Industry Applications

| Type of | Size | | | | | Potential |
|---|---|---|---|---|---|---|
| Pipe | Range | Application | Material | Industries | Limitations | Improvements |
| PVC | Varies | Plumbing, | PVC | Construction, | Cracking, | Structural |
| Pipes | | Irrigation, | | Agriculture, | biofouling, | monitoring, |
| | | Industrial | | Industrial | limited | antibacterial |
| | | Piping | | | sensing | properties, |
| | | | | | | environmental |
| | | | | | | sensing |
| HDPE | Varies | Sewage, | HDPE | Waste | Corrosion, | Corrosion |
| Pipes | | Corrosive | | Management, | leak | resistance, |
| | | Chemicals | | Chemical | detection | advanced leak |
| | | | | | | detection, |
| | | | | | | chemical |
| | | | | | | sensing |
| PPR | Varies | Water | PPR | Residential, | Thermal | Temperature |
| Pipes | | Distribution, | | Commercial | expansion, | monitoring, joint |
| | | Heating | | Heating/Plumbing | joint failures | integrity |
| | | | | | | assessment |

Exemplary applications for the electrically conductive pipes 100 will now be briefly described, however, it will be apparent to one of ordinary skill in the art that electrically conductive pipes 100 may be used in other applications involving piping systems, without departing from the scope of the present disclosure.

Electrically conductive pipes 100 are particularly relevant in the methane gas transport and municipal water sectors, replacing traditional metal pipes prone to corrosion and leaks. The use of electrically conductive pipes 100 in accordance with the present disclosure, enables improved safety and efficiency, allowing for built-in leak detection and pressure monitoring. The traditional use of metal pipes, susceptible to corrosion and methane leaks, is being progressively replaced with plastic alternatives which have shown a 50% reduction in methane emissions due to gas leakage in the network. For example, in the UK, old iron gas mains are systematically being substituted with hydrogen-ready plastic pipes, laying the groundwork for future-proof infrastructure. Electrically conductive pipes 100 could further support this transition by providing built-in leak detection and pressure monitoring capabilities, substantially improving safety and efficiency. For example, the electrical properties of the laser-scribed graphene conductive traces 112 may be utilized for real-time leak detection in a gas pipe. If a leak occurs, it will likely cause a change in the electrical resistance of the laser-scribed graphene conductive trace 112, which could be quickly detected and localized.

The laser-scribed graphene conductive traces 112 are configured to have a high sensitivity to strain and allow for monitoring the structural integrity of the pipe. Any deformation or stress on the pipe might change the conductivity of the traces, providing an early warning of potential structural issues.

In one embodiment, strain sensors may be integrated into the electrically insulative wall to allow for monitoring of structural deformation and stress levels. These sensors detect changes in the pipe's shape or integrity, which could result from ground movement, seismic activity, or internal pressure fluctuations.

In another embodiment, sensors may be mounted on the exterior surface 110 of the pipe 100 and powered using the laser-scribed graphene conductive traces 112, to monitor environmental conditions such as temperature, humidity, and soil moisture. These sensors provide valuable data for assessing external factors that may affect the pipe's integrity, such as temperature fluctuations, soil erosion, or ground movement.

In another embodiment, corrosion sensors may be embedded into/onto the pipe 100, such that the corrosion sensors are capable of sensing structural health, including corrosion in nearby metal pipes such as ferrous, copper, or lead pipes.

In another embodiment, the electrically conductive pipes 100 are used for monitoring pipe integrity using the conductive traces 112 for circuit fault detection. For example, the conductive traces 112 are configured to detect and indicate a circuit fault or failure within a pipe system by monitoring the electrical continuity and resistance of the conductive traces. A disruption in electrical continuity or an abnormal change in resistance is indicative of a fault or failure in the pipe, triggering an alert to the system controller for prompt maintenance or inspection.

In the realm of water distribution, the new standard of incorporating cross-linkable polyethylene pipes facilitates the transport of fluids at reduced and elevated temperatures and pressures. Electrically conductive pipes 100 in this context could enable temperature monitoring and frost protection, preventing pipe damage in colder climates. For example, electrically conductive pipes 100 in accordance with the present disclosure, would be used for monitoring and maintaining fluid temperature within piping systems. This is particularly beneficial in cold climates to prevent freezing or in industrial applications where temperature control is crucial. Localized heating on the inside surface of water carrying water pipes would prevent water freezing and sticking to the inside surfaces and thereby reduce clogging. Moreover, the laser-scribed graphene conductive traces 112 are configured to react to temperature fluctuations, offering the ability to monitor the pipe's thermal status and prevent temperature-related problems. For example, the laser-scribed graphene conductive traces' 112 electrical conductivity is influenced by temperature. Accordingly, temperature may be monitored along the electrically conductive pipe 100, by measuring changes in the conductivity of the laser-scribed graphene conductive traces, thereby preventing or detecting temperature-related issues.

In one embodiment, sensors can be placed inside the electrically conductive pipe 100 and powered using the laser-scribed graphene conductive traces 112. The sensors are configured to monitor water quality parameters such as pH, dissolved oxygen, turbidity, and the presence of specific contaminants. These sensors provide real-time data on water quality, allowing for early detection of contamination events.

In another embodiment, flow sensors can be placed inside the electrically conductive pipe 100 and powered using the laser-scribed graphene conductive traces 112. Installing flow sensors inside the pipe 100 enables monitoring of water flow rates and patterns. Changes in flow rates can indicate leaks, blockages, or irregularities in the system, allowing for timely maintenance and repair.

In another embodiment, pressure sensors can be placed inside the electrically conducive pipe 100 and powered using the laser-scribed graphene conductive traces 112. Pressure sensors inside the pipe 100 can detect variations in pressure, which may indicate leaks, bursts, or other structural issues. Monitoring pressure levels helps prevent water loss and damage to the pipe infrastructure.

In another embodiment, the electrically conductive pipes 100 are used for controlling and monitoring irrigation and liquid transport systems. For example, the laser-scribed graphene conductive traces 112, are configured to interface with irrigation controllers, sensors, and actuators without the need for additional wiring. These traces are energized to transmit control signals and power, and to receive data from moisture sensors, flow meters, and pressure sensors embedded within the irrigation system, thereby enabling automated management and monitoring of irrigation parameters to optimize water usage based on real-time environmental conditions.

In another embodiment, the electrically conductive pipes 100 are used for warding pests from vulnerable irrigation and liquid transport systems. For example, the laser-scribed graphene conductive traces 112 are strategically arranged along the length and the circumference of the tube structure 102. In one embodiment, the conductive traces 112 may be formed from materials other than graphene including graphite or other conductive materials. The laser-scribed graphene conductive traces 112 are configured to be energized with a specific electromagnetic frequency pattern. The frequency pattern is effective in repelling a predetermined type of pest or varmint by disrupting their navigational abilities, which rely on the earth's magnetic field. Consequently, the electromagnetic field is generated by the energized conductive traces, thereby deterring pests from approaching a vicinity of the electrically conductive pipe 100.

In another embodiment, the electrically conductive pipes 100 are used for in-pipe liquid heating and freeze prevention. For example, the conductive traces 112 are integrated within the pipe's structure and configured to act as heating elements. When energized, these traces 112 uniformly heat the water flowing through the pipe, utilizing a controlled electrical current to maintain a predetermined water temperature, thereby facilitating the provision of heated water directly through the pipe system without the need for external heating devices. Additionally, the conductive traces 112 can be energized to prevent the water in the pipes from freezing, effectively winterizing the pipes and allowing them to remain functional even when installed above the frost line.

In another embodiment, the electrically conductive pipes 100 are used for the detection of air pocket formation using interior conductive traces in pipeline systems. For example, the conductive traces 112 on the interior surface of the pipe 100 are configured to detect regions within the pipe run that accumulate air pockets. The conductive traces 112 monitor changes in electrical capacitance and impedance along the pipe 100, which are affected by the presence of air versus water, allowing for real-time identification and localization of air build-up, thereby facilitating timely maintenance or automated adjustments to the pipe system to alleviate the air pockets.

Although plastic is a non-conductive material, the laser-scribed graphene conductive traces 112 permit the plastic (or carbon-containing material) tube structure 102 to be used as a safe conduit for electrical grounding in certain construction applications.

Electrically conductive pipes 100 have applications in sensing various parameters and preventing fouling due to their chemical reactivity. The laser-scribed graphene conductive traces 112 have excellent thermal conductivity which can be leveraged to heat the pipe slightly, preventing condensation or freezing of the gas inside, or to inhibit the growth of microbial or chemical deposits on the pipe's surface that may cause structural damage overtime. Electrical currents applied to the electrically conductive pipe 100 via the power source 118 and laser-scribed graphene conductive traces 112 can prevent the growth of biofilms and other forms of fouling inside the pipes, thus maintaining the flow efficiency and reducing the need for maintenance.

The laser-scribed graphene conductive traces 112 may be utilized to harvest static or other forms of energy, leading to self-sustaining systems that power sensors or other small devices. For private and commercial housing and business development complexes with smart infrastructure, the laser-scribed graphene conductive traces 112 are configured to carry data and power to and from sensors and devices integrated into the building's management system.

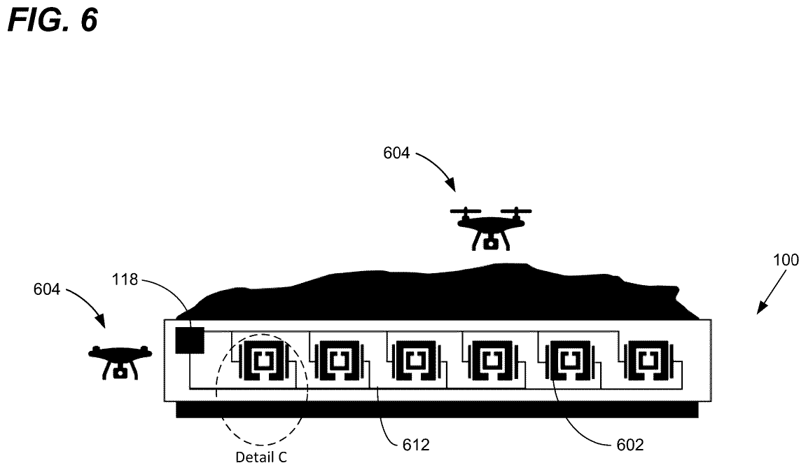

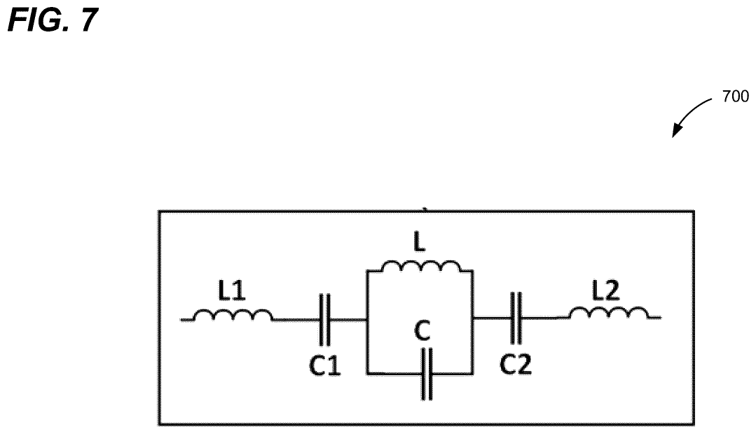

Referring now to FIGS. 6 and 7, the laser-scribed graphene conductive traces 612, in one embodiment, further comprise one or more split ring resonator form factors 602 configured for remotely charging electronic devices 604 at least one of external to the electrically conductive pipe 100 and internal to the electrically conductive pipe. In the illustrated embodiment, the laser-scribed graphene conductive traces 612 comprise concentric split ring resonator form factors 602 that each form an LC equivalent circuit 700 in which is excited by the power source 118 (FIG. 7). This allows for long-range remote charging of electronic devices, such as drones, used in conjunction with piping systems.

In an exemplary embodiment, the laser-scribed graphene conductive traces 112 are configured to define a primary coil. A power transformer is integrated with the primary coil on the electrically conductive pipe 100, complemented by a submersible drone equipped with a secondary coil for contactless inductive charging. PVC serves as the dielectric medium between the primary and secondary coils, optimizing the air transformer's efficiency. This innovative approach enables the transfer of sufficient power for recharging drones' batteries, which could be on the order of tens to hundreds of watts, depending on the coupling efficiency and the size of the gap between the coils. The inherent safety of this contactless charging method within a water-filled pipe is notable, eliminating the risks associated with direct electrical connections. Submersible drones, critical in monitoring the integrity of water pipes, can thus be recharged in situ, significantly enhancing maintenance efficiency. The power source 118 not only facilitates charging but can also house low-frequency transmitters, receivers, and data loggers for comprehensive monitoring.

In an exemplary embodiment, the electrically conductive pipe 100 is configured for wireless communication and sensor applications, and is particularly useful in underground or underwater piping systems. The laser-scribed graphene conductive traces 112, being parallel on the surface of the pipe, can act as an antenna. The effectiveness of such an antenna would depend on several factors, including the electrical properties of the laser-scribed graphene conductive traces 112, the length and spacing of the laser-scribed graphene traces, and the overall design and configuration of the antenna system. This opens possibilities for dual-functionality, combining utility infrastructure with communication or sensor capabilities. For example, the laser-scribed graphene conductive traces 112 further comprise Wi-Fi antennas laser-scribed into residential and municipal plastic pipes offering a discreet alternative to traditional above-ground wiring and unsightly external antennas. This has the potential to dramatically reduce the need for visible wiring infrastructure, as the pipes themselves become conduits for data transmission, with power sources 118 acting as transponders and routers. Moreover, the present disclosure provides a practical solution for the location of non-metallic underground utilities without the need for complex assembly or non-standard pipe dimensions. For example, the present disclosure is configured for transforming pipes into beacons, emanating electromagnetic waves for the purpose of locating buried pipes.

The present disclosure advantageously provides a bottom-up approach for detecting pipes and environmental characteristics that overcomes shortcomings of conventional top-down approaches for detection. In the conventional top-down approaches, the detection process is passive and relies on external interrogation from a transceiver setup, where the transmitter emits various forms of waves such as electromagnetic or sound waves from a distance, typically above the ground. These waves interact with the obscured pipe, and the changes or modulations in the waves are detected by a receiver. Conversely, the bottom-up approach provided with the electrically conductive pipe 100 of the present disclosure, positions the pipe itself as an active component that emits a signal, functioning similarly to a beacon. This signal can be detected by a receiver without the necessity for a separate wave transmitter. This approach not only simplifies the equipment requirements but also enhances the accuracy and efficiency of locating the obscured pipes. The pipes actively participate in their detection, which could revolutionize practices in industries such as utility management, construction, and environmental monitoring.

Importantly, the present disclosure does not preclude the methods of the top-down approach. In fact, certain attributes of the present disclosure will enhance the detection and characterization of non-electrically conductive (e.g., plastic, glass, composite fiber, etc.) pipes by established top-down methods, such as Ground Penetrating Radar (GPR). In GPR applications, the laser-scribed graphene conductive traces 112 of the electrically conductive pipe 100 will enhance contrast of the pipe in GPR images. Moreover, graphene exhibits long-term chemical stability in soil and water environments, which is not the case for metals.

The present disclosure employs graphene-enhanced plastic pipes for improved contrast in ground penetrating radar images. GPR is a highly effective tool for detecting buried objects and structures by sending radar waves into the ground and measuring the reflected signals. GPR more effectively reveals the diameter and location of a plastic pipe, modified with graphene traces, because of enhanced image contrast. Graphene, although not as conductive as copper, still possesses considerable electrical conductivity, especially compared to typical non-metallic materials. This characteristic can influence the radar wave's behavior as it interacts with the graphene-enhanced pipe.

An interaction of graphene traces with radar waves will now be described. The graphene traces along the pipe cause the pipe to exhibit enhanced absorptions and reflections of the radar waves. Although these traces are only 1-mm in width, their continuous length and electrical properties generate detectable anomalies in the radar images. These absorptions and reflections are less pronounced than those from a fully metallic pipe but more significant than those from a standard plastic pipe without any conductive materials.

The primary body of the plastic pipe, being non-metallic, would generally have a lower reflection coefficient for GPR signals. This means the pipe itself might not produce strong reflections unless the radar frequency and settings are specifically tuned to detect such materials. The presence of graphene will enhance the overall visibility of the pipe under GPR due to the increased contrast between the electrical properties of the surrounding soil and the graphene traces on the pipe.

Depending on the concentration and distribution of graphene, it will enhance the overall electromagnetic properties of the pipe to a variable degree, leading to better detection and imaging by GPR. However, given the narrow width of the graphene traces, this effect could be subtle and require high-resolution GPR equipment to resolve clearly.

GPR Image Characteristics will now be described. The graphene traces appear as continuous linear anomalies along the length of the pipe, depending on the orientation relative to the radar wave propagation. Areas beyond the graphene traces will show some degree of shadowing or attenuation in the radar data, where the signal strength behind the traces diminishes. For the case of metal pipes, the shadowing effect is extreme. While GPR will improve the detection of the graphene-enhanced plastic pipe, the visibility and clarity of the detection will depend significantly on the GPR system's specifications (like frequency and resolution), the soil conditions, and the depth of the pipe. The graphene traces provide a unique conductive signature that will help in distinguishing the pipe from purely non-conductive underground objects and soil.

Chemical advantages of graphene over metal traces on plastic pipes will now be described. Graphene compared to common metals like copper, aluminum, bronze, and chromium exhibits markedly different behaviors when it comes to corrosion, particularly in challenging environments such as soil and water. Hence, while plastic pipes with metal traces will yield enhanced GPR images, comparable to plastic pipes with graphene traces, the metal traces will eventually corrode in soil environments and render the pipes difficult to image using GPR, especially at a future time when it is more likely necessary to locate them. On the other hand, graphene is stable and does not corrode in soil environments thereby ensuring the ability to record images of the pipes using GPR many years after the pipes are buried.

Graphene composed of a single layer of carbon atoms arranged in a hexagonal lattice, demonstrates exceptional chemical stability and corrosion resistance. Several factors contribute to its robustness, including:

Chemical Inertness: Graphene is highly resistant to oxidation because it does not have free orbitals for reaction with oxidizers. This stability is a significant advantage in preventing corrosion.

Physical Barrier: Graphene can act as a protective barrier on substrates, significantly reducing the rate of corrosive processes. Even a single graphene layer can reduce metal corrosion rates by over 100 times.

Environmental Resistance: In soil and water environments, graphene's impermeability to gases and liquids means it can protect underlying materials from the ingress of corrosive substances.

A comparative analysis between graphene and metal traces will now be described. Unlike metals that can corrode and lose conductivity, graphene maintains its structural integrity and conductive properties even under adverse conditions. This characteristic makes it particularly suitable for applications requiring long-term stability and reliability in environmental exposure. For ground-penetrating radar applications, the degradation of metal can lead to a loss of signal reflection over time. Graphene's resistance to environmental factors ensures that its conductive properties remain effective for GPR applications, even over extended periods. Therefore, graphene's unique chemical and physical properties make it a superior choice for use as a conductive material in environments where corrosion is a concern. Its ability to withstand harsh conditions without significant degradation offers clear advantages over traditional metals, ensuring longevity and reliability of the conductive traces in applications such as embedded sensors in soil or water.

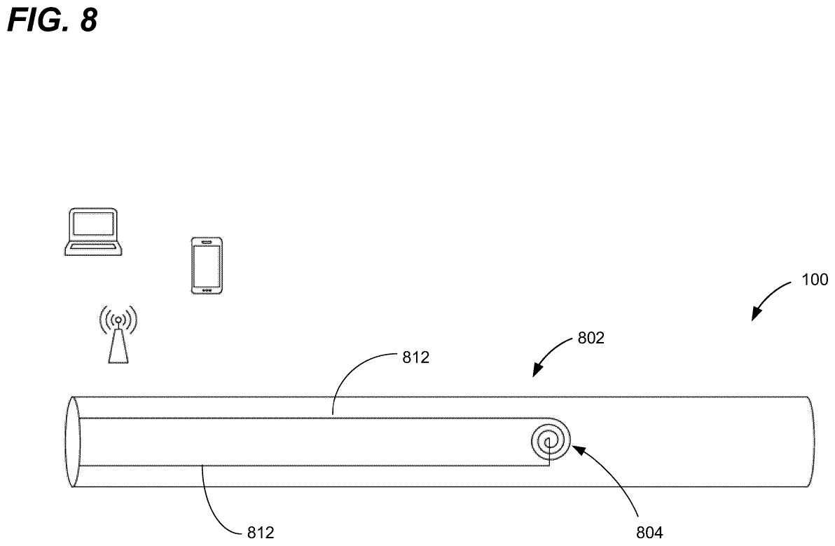

One embodiment of the invention involves the use of laser-scribed graphene conductive traces 112 within plastic pipes to create radiofrequency antennas, particularly for the AM band. These antennas are designed based on the parameters of the radio waves to be generated, and can be scribed on various surfaces of the pipe-exterior 110, interior 108, and within the electrically insulative pipe wall. Several different radiofrequency antenna designs are plausible. For example, in FIG. 8 the laser-scribed graphene conductive traces 812 further comprise one or more dipole antennas 802. The dipole antennas 802 are configured to resonate at 1000 kHz in the center of the AM band. In another embodiment, the laser-scribed graphene conductive traces 812 comprise one or more loop antennas. Loop antennas are ideal for circular laser-scribing inside or on the exterior surface 110 of the pipe 100. The loop design is effective for capturing magnetic components of the radio wave. Moreover, in one embodiment, the laser-scribed graphene conductive traces 812 comprise one or more helical antennas scribed along the length of the electrically conductive pipe 100, thus enhancing the antenna's reception and transmission capabilities in the AM frequency range.

Still referring to FIG. 8, the dipole antennas 802 comprises two parallel laser-scribed graphene conductive traces 812 along the length of the tube structure 102. The laser-scribed graphene conductive traces 812 are configured to undergo metallization through electrochemical deposition to improve their electrical conductivity and overall efficiency as an antenna. Adjacent to the dipole antenna 802, a separate laser-scribed graphene conductive trace 812 forms a surface coil 804 that conforms to the pipe's curvature, functioning as a high-directionality transceiver radiofrequency antenna. The surface coil 804 is designed to emit low-frequency radio waves that assist in precise localization of the pipe's center before excavation. In an exemplary embodiment, the ends of the dipole antennas 802 are connected to a 300 Ohm two-wire conductor, which links the antennas to a radiofrequency power transmitter. This multifunctional approach combines the durability and non-conductivity of PVC with the high electrical conductivity and flexibility of laser-scribed graphene, illustrating a forward-thinking design for infrastructural elements that necessitate both mechanical robustness and sophisticated electronic functionality.

The horizontal orientation of the antenna is crucial; unlike traditional vertical dipoles that emit energy parallel to the Earth's surface, these horizontal dipoles emit perpendicular to the Earth, allowing signals to propagate upwards to the surface where they can be detected. The intensity of the detected signal peaks when a receiver is directly above the antenna, thus over the pipe, which cannot be achieved with metal detectors due to the non-metallic nature of PVC pipes.

The present disclosure incorporates strategic placement of horizontally oriented dipole antennas on municipal water pipes, typically ranging in diameter from 6 to 36 inches and in common lengths suitable for municipal use (often in segments of 20 feet or more), thereby leveraging the inherent length of the pipes to facilitate the transmission of very low frequency (VLF) radio waves. VLF radio waves, within the range of 3-30 kHz, correspond to wavelengths from 10 to 100 kilometers. A quarter or half-wavelength antenna for these frequencies would be impractically long for above-ground use, but when leveraging long stretches of underground municipal pipes, these become viable. For instance, a 20-foot (approximately 6 meters) segment of pipe could effectively be used as part of a larger antenna system for frequencies where a quarter-wavelength is on the order of kilometers, because the antenna need not be a continuous conductor and can consist of multiple segments that collectively resonate at the desired frequency. This design is particularly adept for transmission through soil and rock, which is an essential capability given that higher frequency waves experience significant attenuation in such environments.

As briefly explained above, the present disclosure encapsulates the technological fusion of advanced materials and modern fabrication techniques to create a state-of-the-art antenna system on a plastic pipe or a pipe formed of a carbon containing material. In one exemplary embodiment, the present disclosure employs a dual-antenna system where one is a dipole antenna made from the laser-scribed graphene conductive traces 112 running parallel to the pipe's length. These laser-scribed graphene conductive traces 112 have the potential to be metalized to boost conductivity and effectiveness as an antenna component. The other key element in this assembly is a surface coil made from the laser-scribed graphene conductive trace 112, that wraps around the pipe 100. The surface coil is engineered to serve as a directional antenna for radiofrequency transmission and reception. The surface coil's function is particularly crucial for locating the pipe's central axis, which is invaluable for pre-excavation planning.

The integration of large plastic pipes and radiofrequency (RF) antennas represents a mutually beneficial relationship, leveraging the structural capacity of the pipes to house extensive (in physical length) antenna elements necessary for low-frequency RF communication. These frequencies, typically in the very low frequency (VLF) range of 3-30 kHz, are capable of penetrating 6-10 feet of earth, which higher frequencies cannot due to increased attenuation, especially in waterlogged soil. VLF waves are essential for transmission through dense mediums like rock, dirt, and water, with long antenna elements—a fraction of the wavelength—being crucial for their generation. The synergy between large plastic pipes and RF antennas is exemplified by the present disclosure, exploiting the pipes' large interior to accommodate expansive antenna structures vital for low-frequency communication. Operating predominantly in the VLF spectrum, these antennas can penetrate subterranean depths unreachable by higher frequencies, which suffer rapid signal decay in moisture-rich soils. Thus, VLF communication becomes indispensable for signal propagation through solid earth and liquid barriers.

Antenna designs like helical and loop antennas, which can be laser scribed onto pipes, focus RF energy in a directed manner, allowing for precise location pinpointing—a vital feature as plastic pipes are undetectable by metal detectors. The laser-scribed helical and loop antennas focus and direct RF energies for pinpoint accuracy in locating subsurface utilities, a significant upgrade over traditional detection methods rendered ineffective by plastic's non-metallic nature.

Additionally, the laser-scribed circuits, such as coils on the pipes, can sense structural pressure changes of the pipe's surrounding ground environment through variations in inductance of an LC circuit and the corresponding changes in the resonance frequency, enabling constant monitoring of the pipe's integrity. For example, in-pipe circuits can detect minute shifts in soil pressure via changes in the inductance of an LC circuit, offering real-time monitoring of structural integrity. This becomes particularly advantageous in seismically active regions like California, where post-earthquake assessments are critical. If the pipe distorts due to ground pressure changes or nearby digging, these embedded sensors can modify the emitted LC circuit resonance frequency, serving as an early warning system to prevent potential damage from excavation activities. For example, should the pipes deform due to external pressures or subterranean movements, the smart sensor system could adjust its resonance frequency, signaling potential risks without the need for visual inspections, a revolutionary step in proactive maintenance and safety assurance.

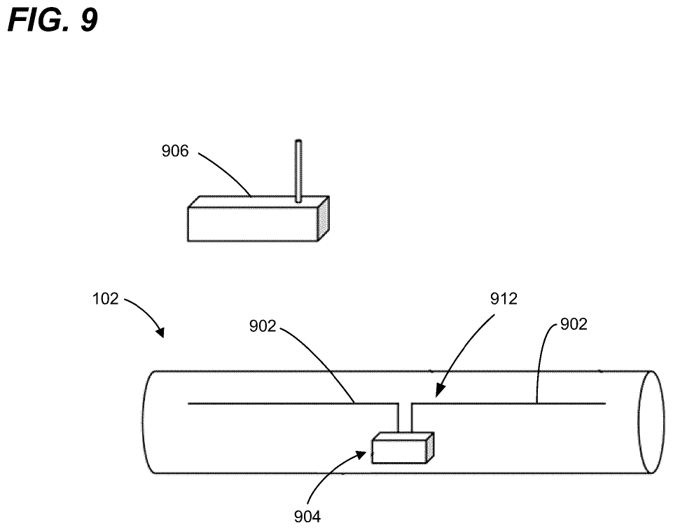

Referring now to FIG. 9, the laser-scribed graphene conductive traces 912, comprising antenna traces 902 integrated at least one of into or onto the tube structure 102, are connected to an AM transmitter 904. The AM transmitter 904 is configured to inject a 3 kHz constant tone signal amplitude modulated on the 1000 kHz carrier radiofrequency. This frequency is centrally located in the AM band, optimizing transmission effectiveness. The transmitted signal, amplitude modulated at 3 kHz, is broadcasted from the pipe, which can be buried underground. FIG. 9 also depicts an AM radio receiver 906 detecting the signal, with signal strength varying according to the distance from the electrically conductive pipe 100. For example, the strength of the received AM frequency is directly proportional to the proximity of the AM radio detector to the pipe 100.

The market for outdoor children's activity play structures is burgeoning, projected to reach a significant value of $9.6 billion by 2030, growing at a CAGR of 7.00%. Such play structures, known for their simplicity, attractiveness, and easy installation, are becoming increasingly affordable and customizable. The inventive modular pipe system is a cornerstone of this sector, consisting of various elements like elbows and T-connectors that facilitate the creation of complex structures like forts or space station designs. These connectors enable the assembly of PVC pipes into versatile configurations, allowing parents and vendors to personalize play areas. For example, play forts can be designed with PVC pipes, using elbow connectors for angled structures and T-connectors for multi-level designs. Pads can be added inside the pipes for comfort, turning them into crawl spaces safe for children. One attractive configuration might be a large PVC pipe structure with a central hub and radiating arms, each ending in a dome with transparent sections to let in light. Such designs appeal to children's sense of adventure and provide a safe play environment shielded from rain and direct sunlight. T-connectors facing upwards could introduce natural light and function as periscopes or telescope mounts. The cost of PVC pipe sections and connectors is relatively low when compared to pre-made playsets, which can range from a few hundred to thousands of dollars. A basic modular PVC playset could start as low as $2000-$3000, relying on the affordability and wide availability of PVC pipes and fittings. This cost-efficiency, coupled with the intrinsic safety and customization potential of PVC play structures, positions them as an innovative solution within the outdoor play equipment market.

In one embodiment, the electrically conductive pipes 100 are used to revolutionize children's playground equipment. Moreover, the present disclosure enhances safety and interactive play within children's playground equipment. For example, the integration of the laser-scribed graphene conductive traces 112 into children's playground equipment enables multiple functionalities such as powered speakers, video displays, LED lights, and light shows, and eliminates exposed wires. Powered speakers and video displays can be used to create an immersive play area where music and educational or entertaining movies can be shown, adding auditory and visual dimension to the playground experience. Moreover, with electrically conductive pipes 100, LED installations can be incorporated to create dynamic and colorful light shows, which not only enhance the aesthetic appeal of the playground, but also promote sensory stimulation for children. Furthermore, the unique properties of the laser-scribed graphene conductive traces 112 permit adhesive spots for child-friendly paints. For example, the laser-scribed graphene conductive traces 112 provide a canvas for children to express their creativity with paints that adhere permanently. The incorporate of the present disclosure into playground design not only augments the functionality and appeal of play spaces, but also encourages interactive and creative activities, fostering an environment conductive to childhood development.

Hobbyists can exploit electrically conductive pipes 100 for a variety of creative applications, from constructing decorative railings with integrated lighting to fashioning novel art installations. The electrically conductive pipes 100, with laser-scribed graphene conductive traces, lend themselves to a myriad of embellishments, such as LED arrays for seasonal displays or sound generators for dynamic art pieces. For instance, during Halloween, such electrically conductive pipes 100 may be the backbone of elaborate displays, providing both structural support and electrical connectivity for lights and sound effects, without the clutter of external wiring.

In one application, the electrically conductive pipes 100 may also be used in distributed soil moisture sensing. In this application, the laser-scribed graphene conductive traces 112 are arranged along the length of the tube structure 102 and configured to function as sensor nodes within a distributed soil moisture sensing network. Each sensor node is capable of independently measuring the dielectric constant of the surrounding soil, thereby providing a comprehensive map of soil moisture data across various segments of an irrigation system. Furthermore, the sensor nodes may be integrated with the pipeline's flow regulation system, forming a self-regulating feedback loop that continuously monitors and automatically adjusts flow parameters to ensure optimal irrigation without outside interaction.

In another embodiment, the electrically conductive pipes 100 are used for distributed pressure sensing using integrated conductive traces in pipeline systems. For example, the conductive traces 112 are positioned along the interior surface of or embedded within the walls of the pipe 100 and are configured as part of a distributed pressure sensing system. The traces, forming a network of capacitive or resistive sensors, detect variations in electrical properties due to changes in internal pressure across the entire length of the pipe system. The system is calibrated to convert these variations into precise, localized pressure measurements, enabling real-time monitoring and control of internal pipe pressure. This distributed sensing capability provides alerts and data for system management, optimization, and preventive maintenance, enhancing operational safety and efficiency.

Additionally, the conductive traces 112 may be connected to a variety of actuators embedded within the pipe walls, including valves, sphincters, gaskets, solenoids and other pressure-adjusting mechanisms. These actuators are able to automatically adjust based on pressure changes detected by the electrically conductive traces in the pipeline. This arrangement creates an effective feedback loop that helps maintain optimal system performance, mitigates potentially dangerous pressure build-ups, and enhances the overall integrity and safety of the pipeline infrastructure.

Drones equipped with RF sensors and GPS technology offer utility companies valuable insights for efficient infrastructure maintenance. RF sensors onboard the drone are sensitive to variations in RF field strength caused by factors such as leaks, corrosion, or structural weaknesses in underground pipelines. These sensors detect anomalies in the RF signal, alerting utility companies to potential issues before they escalate into costly repairs or service disruptions. By precisely mapping RF field strength variations along underground pipelines, utility companies can prioritize maintenance activities based on the severity and location of detected anomalies. This data-driven approach maximizes resources and minimizes downtime, enhancing overall operational efficiency. Drones equipped with RF sensors enable utility companies to implement preventive maintenance strategies tailored to specific pipeline conditions. Regular inspections using drones equipped with RF sensors allow for proactive monitoring of pipeline health, reducing the risk of unexpected failures and extending the lifespan of infrastructure assets.

Drones equipped with RF sensors and GPS technology play a crucial role in mapping underground utility networks, providing essential information for urban planning and construction projects. RF sensors onboard the drone detect variations in RF field strength emitted by underground utilities, including water or gas pipelines. By correlating these variations with GPS coordinates, utility companies obtain high-resolution data on the precise location and depth of underground pipelines, including unauthorized (illegal, black market, contraband, unsanctioned, clandestine) pipelines, with minimal disruption to surface infrastructure. Detailed maps of underground utility networks inform urban planning decisions, such as the location of new construction projects or utility upgrades. RF sensor data collected by drones enables utility companies to accurately map the underground infrastructure, including unauthorized pipelines, reducing the risk of accidental damage during construction activities and supporting sustainable urban development. During emergencies, rapid access to up-to-date utility maps is critical for effective emergency response planning. Drones equipped with RF sensors allow utility companies and emergency responders to quickly assess the impact of incidents on underground infrastructure, identify unauthorized pipelines, prioritize restoration efforts, and minimize service disruptions.

The applications explained above for electrically conductive pipes 100 in accordance with the present disclosure, combine inherent advantages such as durability and chemical resistance, of pipes formed of plastic or other carbon-containing materials, with functionalized laser-scribed graphene conductive traces 112. The present disclosure provides an enhanced electrically conductive pipe 100 including technological advancements integrated directly into the pipe's structure. The ability to integrate sensing and communication systems within the pipes creates new markets and applications. This innovation aligns with sustainability goals by potentially reducing the need for additional infrastructure and maintenance. Moreover, systems and methods in accordance with the present disclosure provide advanced discovery, monitoring, and communication systems to meet the demands of future technologies and applications.

A method of manufacturing electrically conductive pipes 100 will now be described before turning to a manufacturing system 1300 for executing the method thereon.

A manufacturing method for manufacturing the electrically conductive pipe 100 has been augmented using a high-precision laser scribing technique to form the laser-scribed graphene conductive trace 112. The process begins with the localized conversion of a carbon-containing material (e.g., plastic) of the tube structure 102, to graphene. In an optional step, the graphene is transformed into highly conductive metal via a controlled localized electroplating reaction. This modification not only bestows electrical properties upon the inherently non-conductive plastic material, but also potentially enables applications such as providing electrical power to electrical circuits, which could be used to image and monitor the internal contents of the pipe without invasive procedures. The precision of the laser scribing and subsequent coating is critical in environments with high moisture, ensuring the integrity of the graphene electrically conductive trace and its functionality. The resulting graphene-enhanced electrically conductive pipe 100 supports smart infrastructure components, with integrated sensing and transmission/reception capabilities. Individual steps of the manufacturing method will now be described.

In an initial step, the tube structure 102 is formed from a plastic precursor material or a carbon-containing material that is compatible with laser-induced graphene transformation. Moreover, the material should be compatible with metal integration. Next, if applicable, metal particles or compounds are embedded into the material. For example, to form PVC pipes to be used as the electrically conductive pipes 100, the process begins with the polymerization of vinyl chloride monomers, forming polyvinyl chloride resin. The resin is then blended with various additives to enhance material characteristics. The mixture is then subjected to a heating process. Once heated, the material becomes malleable, allowing it to be formed into the tube structure 102 through forming processes such as extrusion. During extrusion, the molten PVC resin passes through a die, shaping it into the tube structure 102. The tube structure 102 is then cooled and solidified. Subsequent processes may involve cutting tube structures 102 into desired lengths and subjecting the tube structures to various quality control tests to ensure durability and performance.

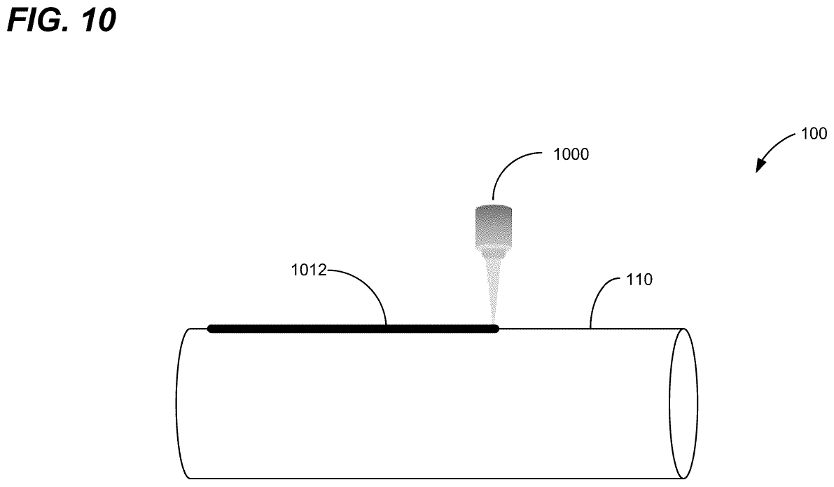

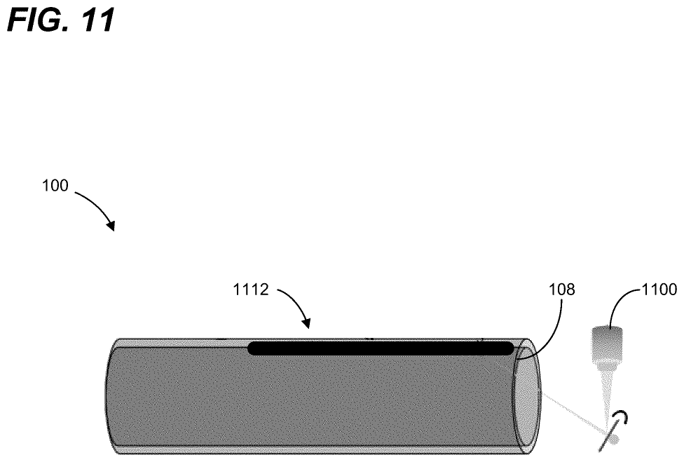

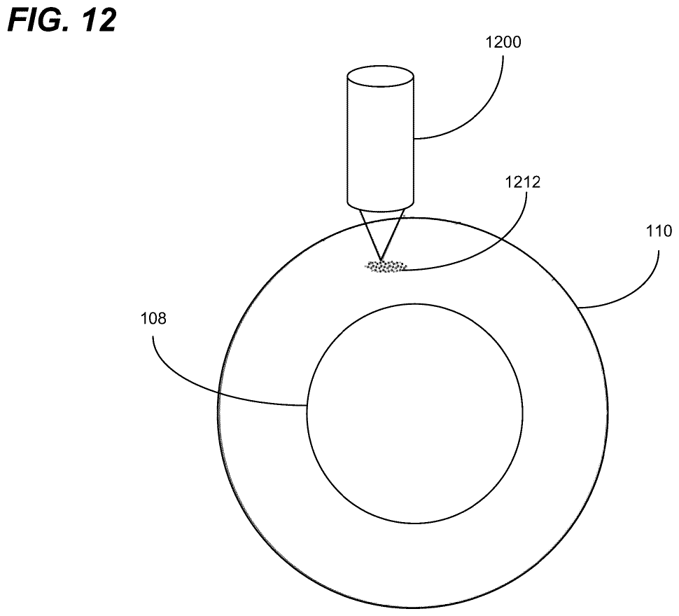

Referring now to FIGS. 10-12 the tube structure 102 is subjected to a laser scribing process to form the laser-scribed graphene conductive traces 1012, 1112, 1212. In preparation, a high-powered laser 1000, 1100, 1200 such as a femtosecond laser, is positioned proximate the tube structure 102 in at least one of an embedding position, interior surface position and exterior surface position. Next, the tube structure 102 is irradiated in a predefined trace pattern with the laser 1000, 1100, 1200 to induce precursor material reactions that convert the precursor material of regions of the tube structure into one or more laser-scribed graphene conductive traces 1012, 1112, 1212 that are at least one of embedded within the electrically conductive pipe 100 (FIG. 12), on the interior surface 108 (FIG. 11) of the electrically conductive pipe, and on the exterior surface 110 (FIG. 10) of the electrically conductive pipe.

In one example, the precursor material reactions comprise at least thermal and photochemical reactions. For example, the laser 1000, 1100, 1200 induces photochemical and thermal reactions that convert the precursor material of the tube structure 102 into a laser-scribed graphene conductive trace 1012, 1112, 1212 comprising a porous composite conductive trace, which could have metal centers. The laser-scribing process converts halo hydrocarbons in the precursor material (e.g., PVC) into electrically conductive graphene. The physics behind the process of the laser-scribed graphene conductive trace formation involves the interaction of light pulses from the laser 1000, 1100, 1200, in one example, with a polyimide coating of the precursor material. The intense energy of the laser pulses causes a localized increase in temperature, leading to the transformation of polyimide into graphene, a highly conductive material. The chemistry and photochemistry involved in the graphene formation process are complex. The high temperatures generated by the laser pulses cause the polyimide to undergo a series of chemical reactions, including dehydrogenation and carbonization, resulting in the formation of graphene. The photochemical aspect involves the interaction of laser light with the material, which can induce electronic transitions, ionization, and chemical reactions.

FIG. 12 illustrates a cross-section of the tube structure 102, detailing the integration of a laser-scribed graphene conductive trace 1212 within the electrically insulative wall. The laser 1200 focuses a beam into the tube structure 102. The beam's focal point is marked by a small, dense cluster of dots, symbolizing the region of the tube structure 102 where the laser-scribed graphene conductive trace 1212 is being formed. In the illustrated embodiment, the wall thickness of the electrically insulative wall of the tube structure 102 is uniform throughout. The laser-scribed graphene conductive trace 1212 is scribed internally, suggesting that it is completely encapsulated by the tube structure material, providing inherent insulation from external and internal environments. The internalization of the laser-scribed graphene conductive trace 1212 offers several advantages. Being shielded within the electrically insulative wall, the laser-scribed graphene conductive trace 1212 is protected from environmental factors such as moisture, chemicals, or physical abrasion that could otherwise degrade exposed traces. Moreover, this method foregoes the need for additional protective layers or coatings, simplifying the manufacturing process and potentially reducing costs.

The laser-scribed graphene conductive trace 1012, 1112, 1212 is small relative to the thickness of the electrically insulative wall, depicting a high degree of control over the laser scribing process. Intricate patterns or multiple parallel traces can be laser scribed as necessary for more complex circuitry or antenna designs. In one embodiment, the tube structure 102 is irradiated in a predefined charger pattern with the laser 1000, 1100, 1200 to induce precursor material reactions that convert the precursor material into one or more split ring resonator form factors 602 configured for remotely charging electronic devices at least one of external to the electrically conductive pipe 100 and internal to the electrically conductive pipe. In another embodiment, the tube structure 102 is irradiated in a predefined dipole antenna pattern with the laser 1000, 1100, 1200 to induce precursor material reactions that convert the precursor material into one or more dipole antennas 802 configured for frequency transmission.

The precision of the laser-scribing process is paramount, as it must ensure that the transformation of the polymer to graphene occurs exclusively within the targeted area, avoiding any damage or alteration to the rest of the tube structure 102. The targeted transformation is achieved through careful selection of the laser's wavelength and intensity, tailored to avoid absorption by the precursor material at lower intensities and to only induce the thermochemical conversion to graphene where the laser's focus achieves the necessary high energy density. For example, the laser wavelength is critical to ensure it does not resonate with the electronic, vibronic, or any energy-absorbing modes of the precursor material at low laser intensities. Consequently, only the laser light focused within a particular region possesses the requisite energy to induce a thermochemical transformation of the polymer into graphene. This transformation occurs specifically in the area where the laser 1000, 1100, 1200 is intensely concentrated, allowing for precise placement and formation of the laser-scribed graphene conductive traces 1012, 1112, 1212.

In further steps, either prior to or during the laser-scribing process, the laser parameters of the laser 1000, 1100, 1200 are adjusted to achieve a target configuration of the laser-scribed graphene conductive traces 1012, 1112, 1212. For example, laser parameters such as power, speed, and focus are controlled to achieve a desired thickness and quality of graphene, targeting the formation of few-layer graphene. Moreover, the laser-scribing process can be augmented by introducing gases, like argon or xenon, to prevent oxygen interference during the laser reaction. Reactive gases and liquid reagents can also be introduced to interact with the pipe components, producing new materials with desirable properties. This includes the formation of metal catalytic centers for sensing applications and antibacterial functionalities.

After the laser-scribing process, the laser-scribed graphene conductive traces 1012, 1112, 1212 are covered with an insulating material. Furthermore, at least one of a graphene-based ink, and graphene-based paste may be applied to the predetermined trace pattern to form the one or more laser-scribed graphene conductive traces 1012, 1112, 1212. Such steps are optimal when forming the laser-scribed graphene conductive traces 1012, 1112, 1212 on the interior surface 108, and exterior surface 110. In another optional step, the laser-scribed graphene conductive traces 1012, 1112, 1212 are strengthened with a conductive material such as copper. Furthermore, connections may be established between pipes and laser-scribed graphene conductive traces thereof by using a paste or conductive metal tape to bride the connections. In another embodiment, joints (elbows, 3-ways, etc.,) used for connecting the pipes may be configured with laser-inscribed conductive portions that can be used to connect pipes without a loss of connection.

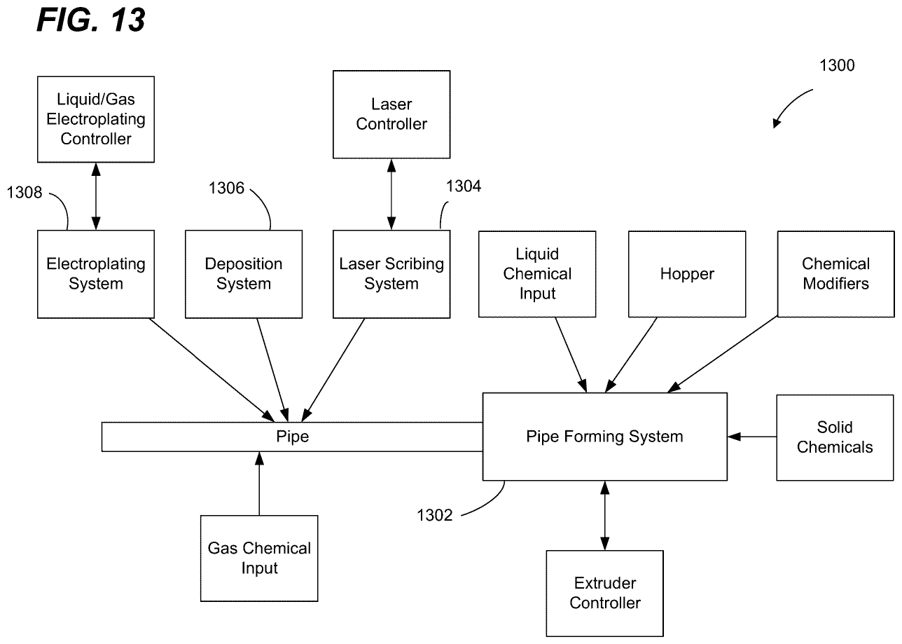

Referring now to FIG. 13, a manufacturing system in accordance with the present disclosure is generally indicated at reference number 1300. Broadly, the manufacturing system 1300 comprises a pipe forming system 1302, a laser scribing system 1304, a deposition system 1306, and an electroplating system 1308. The manufacturing system 1300 is configured to produce innovative electrically conductive pipes 100 with integrated laser-scribed graphene conductive traces 112. The individual components of the manufacturing system 1300 will now be described in greater detail.

The pipe forming system 1302 is configured to form the precursor material into the tube structure 102 comprising a continuous pipe. Moreover, the pipe forming system 1302 is configured to form the tube structure 102 to include the electrically insulative wall having an interior surface 108 and exterior surface 110 spaced apart by a pipe thickness. In an exemplary embodiment, the pipe forming system 1302 comprises a plastic pipe extruder configured for heating, melting, and forming the precursor material (e.g., PVC, HDPE, etc.,) into a continuous pipe shape. Furthermore, the plastic pipe extruder comprises a hopper, barrel and rotating screw, heater, and die. The hopper is configured for feeding precursor material pellets into the extruder. The barrel encases the rotating screw which transports, compresses, and melts the precursor material. The heater is arranged along the barrel to control the temperature of the precursor material. The die is at the end of the barrel and configured to shape the molten precursor material as it exits the extruder.

The laser scribing system 1304 is configured to move along at least one of a length and circumference of the tube structure 102. Furthermore the laser scribing system 1304 is configured to irradiate the tube structure 102 in a predefined trace pattern to induce precursor material reactions that convert the precursor material into one or more laser-scribed graphene conductive traces 112 that are at least one of embedded within the electrically insulative wall of the tube structure, on the interior surface 108 of the electrically insulative wall of the tube structure, and on the exterior surface 110 of the electrically insulative wall of the tube structure. In one embodiment, the laser scribing system 1304 comprises a femtosecond laser that is configured to deliver a high concentration of photons in space and time to create a high temperature and pressure microenvironment on or within the tube structure 102. This localized virtual reaction chamber facilitates the conversion of halo hydrocarbons in the precursor material into electrically conductive graphene.

In an exemplary embodiment, a laser scribing system 1304 in accordance with the present disclosure comprises a dynamic laser engraving system that thermochemically converts the precursor material to precise graphene patterns integrated into the tube structure 102. A gas stream additionally provides gaseous reagents that react with the precursor material during laser-scribing to impart physio-chemical attributes to the thermochemically-generated graphene traces by introducing additional reaction pathways to product materials. The chemically modified graphene-based traces can serve as sensors. In another embodiment, the laser scribing system 1304 comprises a laser head, control unit, and motion system. The laser head is configured to move 360 degrees about the tube structure 102. The control unit is used to adjust the laser's intensity and pattern in real-time. The motion system enables the laser to follow precise patterns along the length and circumference of the tube structure 102.

The deposition system 1306 is configured to deposit at least one of graphene-based ink and graphene-based paste into the one or more laser scribed graphene conductive traces 112. For example, once the graphene trace pattern is scribed, as an option, an additional graphene ink or paste, chemical, or other desirable material can be applied to the trace patterns. In an exemplary embodiment, the deposition system 1306 comprises a precision deposition nozzle and a roller brush or applicator. The precision deposition nozzle is configured to move synchronously with the laser scribing system 1304 to add material to the scribed patterns. The roller brush or applicator comprises a mechanical system that ensures graphene or other additives added to the scribed patterns, cover the laser-scribed graphene conductive traces 112 completely.

The electroplating system 1308 is configured to electroplate the laser-scribed graphene conductive traces 112 with metal to increase conductivity. In an exemplary embodiment, the electroplating system 1308 comprises one or more conductive brushes, a power supply, and a control system. The conductive brushes are saturated with an electrolyte solution containing a desired plating metal such as copper, gold, or silver. Moreover, the conductive brushes are configured to apply a thin layer of electrodeposited material to the laser-scribed graphene conductive traces 112 without the need for the tube structure 102 to be submerged in a plating bath. The power supply provides current to the conductive brushes. The control system is configured to monitor and adjust the current and movement of the conductive brushes to ensure consistent plating.

In an exemplary embodiment, the manufacturing system 1300 also comprises an insulating material coating system configured to apply insulating material to the laser-scribed graphene conductive traces 112. The insulating material coating system provides a protective layer over the laser-scribed graphene conductive traces 112, thereby ensuring electrical insulation, longevity, and functionality. In an exemplary embodiment, the insulating material coating system comprises a spray nozzle, reservoir, and control unit. The spray nozzle is capable of 360-degree rotation around the tube structure 102. The reservoir contains the insulating material, which is in one embodiment plastic material. The control unit is configured for adjusting parameters of the spray nozzle such as spray pattern, flow rate, and movement to ensure even coating over the laser-scribed graphene conductive traces 112.

Systems and methods in accordance with the present disclosure, exemplify a pioneering approach in the production of plastic pipes embedded with laser-scribed, electrically conductive traces. The end-to-end system not only produces electrically conductive pipes but also integrates sophisticated sensor technologies directly into piping systems. The present disclosure presents a low-cost solution, demonstrating the feasibility of integrating conductive traces into standard piping with minimal cost implications for consumers. This strategic augmentation is not merely an incremental step in manufacturing efficiency but opens doors to a burgeoning market particularly appealing to hobbyists and artisans.

An exemplary method for detecting electrically conductive pipes 100 in accordance with the present disclosure will now be described.

First, a constant tone is recorded using the AM 5-minute transmitter record feature. For example, the tone can be 3000 Hertz. Next, transmit the 3000 Hz tone continuously for 5 minutes and set for continuous repeat. Once successful, clarify the procedure for how to do this based on manual instructions. Once the 3000 Hz sound is audible on an AM radio, then move the radio closer or further away from the antenna to see if the radio sound amplitude changes. If it does, then an audible means for testing AM radio RF signal strength exists. Next, the audible sound must be converted to a digital reading. To do so, connect a pair of wires to the speaker connections inside the AM radio. The wires can then be connected to a digital voltmeter using banana plugs. Set the voltmeter to AC volts for making measurements.

Use a long measuring tape and place the AM radio at different measured distances from the antenna in certain directions (these numbers will be the independent variable measurements). Plot the distance away from the antenna in meters on the x-axis and the corresponding measured AC voltage (dependent variable) on the y-axis. Move linearly away from the antenna by 0.5-meter increments. Make sure to hold the radio in the exact same orientation for each measurement. Make sure to set the radio volume to a value that can capture the range from closest (loudest) to furthest (softest) distance from the antenna without sound distortions. Take note as to the radio orientation with respect to the pipe's long axis. Make plots and include a diagram of the orientation for data collection. Generate many RF field graphs. Several of the multimeter digits may flicker; make observations to discuss the uncertainty in the AC voltage measurements. Also, make an estimate of the uncertainty in the position measurements. The plots should look quite smooth.

Having fully described the invention in such clear and concise terms as to enable those skilled in the art to understand and practice the same, the invention also includes the features set out in the following clauses:

In an aspect, a method for embedding conductive graphene traces within walls of a plastic pipe comprises selecting a laser with a specific wavelength that is not strongly absorbed by the plastic material of the pipe under low light intensity, focusing a light of the laser at the center of the pipe wall to induce a thermochemical transformation of the polymer into graphene to laser scribe the pipe, and creating a conductive graphene trace within the interior of the pipe wall without altering the external surface of the pipe. According to this method, the plastic pipe is made of PVC material, polyimide material, or polyethylene material. Further, the method includes adjusting the laser intensity to control the depth of the conductive graphene trace within the pipe wall. In addition, the method may be performed in a controlled environment to prevent contamination during graphene formation. The method further comprises using the conductive graphene trace for sensing applications within the pipe.

In an embodiment, the conductive graphene trace is configured for at least one of the following: electrical signaling and/or power transmission; having antibacterial properties to enhance the pipe's functionality in water supply systems; activating by the application of at least one of a current and voltage is patterned in a specific design to facilitate unique electrical circuit configuration traces; transmitting data signals in communication applications; compatibility with various pipe joint types, ensuring electrical continuity across pipe sections; and monitoring the structural integrity of the pipe through changes in electrical resistance.

The method above, which embodies aspects of the present disclosure, further comprises: adding metal precursors in extruded plastic material of the plastic pipe, at the laser focus point, to introduce metal catalytic reaction centers into the conductive graphene trace; creating a plurality of conductive graphene traces within the pipe wall for complex electronic circuitry designs; incorporating the use of argon or xenon gas during the laser scribing process to create an inert atmosphere, thereby preventing oxidation and ensuring purity of the conductive graphene traces; using a computer-controlled laser scribing system for precision and repeatability in conductive graphene trace formation; executing a post-laser scribing treatment process to enhance electrical properties of the conductive graphene trace; and/or testing at least one of an electrical conductivity and integrity of the conductive graphene trace. The laser scribing may be conducted in multiple passes to increase the thickness of the conductive graphene traces for enhanced conductivity. In an embodiment, the diameter of the plastic pipe is in an inclusive range from 0.5 inches to 48 inches to accommodate various industrial and residential applications and/or the post-laser scribing treatment process comprises annealing. In an embodiment, the laser scribing process is integrated into a pipe manufacturing line for continuous and efficient production.

In another aspect, a plastic pipe with internally embedded conductive graphene traces comprises a plastic pipe body made from a material selected to allow laser-induced thermochemical transformation into graphene and one or more internally embedded conductive graphene traces, formed by a focused laser scribing process within the walls of the pipe. Moreover, the one or more internally embedded conductive graphene traces are configured in predetermined configuration for applications including at least one of electrical signaling, power transmission, and sensing. According to an embodiment of the plastic pipe, the material of the plastic pipe is formed of a suitable polymer that is capable of being transformed into graphene such as PVC. The conductive graphene traces are: insulated from external and internal elements by surrounding pipe material; configured for being activated or controlled through external electrical sources; configured for advanced sensing capabilities for real-time monitoring of at least one of fluid flow and pipe integrity; and/or produced using a laser with a specific wavelength and intensity to precisely control trace formation.

In addition, plastic pipe, which embodies aspects of the present disclosure, comprises at least one of additional layers and coatings on the internal or external surfaces for enhanced functionality or protection and/or at least one of connectors and junctions compatible with the conductive graphene traces for continuous electrical function. According to embodiments of the plastic pipe, the predetermined configuration optimizes electrical properties of the conductive graphene traces. Moreover, the pipe may be configured for use in water supply systems with antibacterial properties in the conductive graphene traces or for use in industrial applications requiring high durability and resistance to harsh environmental conditions.

In yet another aspect, a radiofrequency antenna system comprises a plurality of laser-scribed graphene conductive traces forming an antenna within a plastic pipe for transmitting AM band frequencies. In this system, the antenna is configured as at least one of a dipole, a loop, and a helical antenna based on required transmission parameters. The system further comprises an AM transmitter connected to the conductive traces for injecting a modulated signal, which is, for example, a 3 kHz tone carried on a 1000 kHz AM frequency.

In yet another aspect, a method for locating a buried plastic pipe using an AM radio detector comprises: transmitting a constant tone on the AM band with a laser-scribed graphene antenna on the buried plastic pipe. The laser-scribed graphene antenna may be internally embedded within the walls of the plastic pipe for protection from environmental elements and the strength of the received signal by the AM radio detector indicates proximity to the buried pipe.

In yet another aspect, a plastic pipe comprises an integrated graphene antenna designed for specific radio frequency transmission and reception in the AM band. The integrated graphene antenna is configured for specific radio frequency transmission and reception in the AM band and/or maximizing transmission efficiency and minimizing interference. In addition, the plastic pipe is equipped with a mechanism to modulate and transmit radio signals at predetermined frequencies for specific applications.

In yet another aspect, a system for creating electrified plastic pipes comprises: a plastic pipe extruder configured to heat, melt, and form plastic material into a continuous pipe shape; a laser engraving system positioned subsequent to the extruder and configured to scribe a predefined carbon pattern onto the pipe exterior or interior surfaces; an application mechanism for applying at least one of a graphene-based material and metal-based material onto the scribed pattern; and a coating station for applying an insulating layer over the conductive traces. The plastic pipe extruder includes a hopper for feeding plastic pellets and the plastic material comprises PVC, HDPE, or cross-linkable polyethylene. In an embodiment, the laser engraving system includes a control unit to adjust laser intensity and spot size. Moreover, in the laser engraving system, at least one of: the graphene-based material includes additional metal plating, the application mechanism includes a precision deposition nozzle; the coating station includes a spray nozzle capable of 360-degree rotation; the insulating layer is a plastic coating; and the graphene-based or metal-based material is applied via a roller or a brush applicator. In addition, the system comprises a brush electroplating station with conductive brushes and is capable of moving along the length and circumference of the pipe.

In yet another aspect, a method for fabricating electrified plastic pipes comprises: extruding plastic material to form a continuous pipe; laser scribing a conductive pattern of carbon onto the pipe surface; applying at least one of a graphene-based ink and paste into the scribed pattern; and coating the conductive pattern with an insulating material. The extruding step includes heating and melting plastic pellets and the laser scribing is performed with a femtosecond laser or a carbon dioxide laser. In an embodiment, the conductive pattern comprises dipole antenna elements and the graphene-based ink is created or applied synchronously with the laser scribing. The method further comprises electroplating the graphene-based ink with a metal. According to one or more embodiments of the method, the insulating material is applied via a controlled spray pattern, coating provides environmental protection for the conductive pattern, the conductive pattern is capable of sensing environmental changes, and/or the conductive pattern is utilized for electrical grounding.

In yet another aspect, a laser-scribed plastic pipe for use in utility infrastructure comprises a non-conductive PVC body, at least one conductive graphene trace scribed onto the surface of the PVC body, and an insulating layer covering the conductive graphene trace. The non-conductive PVC body may be configured for sewage management. The conductive graphene trace is configured to conduct electricity, scribed in a pattern to form a dipole antenna, and/or connected to a power source. In an embodiment, the insulating layer is a plastic coating applied to preserve the conductivity of the trace. The laser-scribed plastic pipe further comprises a surface coil graphene trace for directional antenna functionality. The conductive graphene trace is applied for environmental monitoring, flow detection, and/or structural health monitoring.

In yet another aspect, an electrified pipe system comprises one or more plastic pipes, a series of laser-scribed graphene conductive traces integrated into the pipe's structure, and means for real-time leak detection via resistance monitoring of the conductive traces. The laser-scribed graphene conductive traces are preferably metalized to enhance conductivity. In an embodiment, the electrified pipe system further comprises one or more of a wireless communication module connected to the laser-scribed graphene conductive traces, an external power source for electrifying the laser-scribed graphene conductive traces, an alert mechanism for detected leaks, and a user interface for monitoring leak status. According to one or more embodiments, the laser-scribed graphene conductive traces are configured to function as antennas for signal transmission, the plastic pipes are utilized in underground or underwater installations, the laser-scribed graphene conductive traces are configured for detecting specific leak sizes, the laser-scribed graphene conductive traces are applied in a predefined pattern, and/or the electrified pipe system is adaptable for various pipe diameters or lengths.

In yet another aspect, a method for monitoring the structural integrity of pipe systems comprises utilizing laser-scribed graphene conductive traces on one or more plastic pipes and analyzing conductivity changes to identify potential structural issues. In an embodiment, the conductivity analysis is automated via a computer system. The method further comprises performing conductivity checks periodically for ongoing monitoring, enabling real-time alerts to a control center during structural compromise, and/or incorporating redundancy in the conductive trace system for reliability. The method is preferably applicable in seismically driven active areas for enhanced safety and/or is adaptable to different pipe materials. Aspects of this method may be coupled with GPS data for precise location mapping, utilize machine learning algorithms for pattern recognition in conductivity changes, and/or be integrated with mobile applications for remote monitoring. In an embodiment, conductivity measurements are stored in a cloud base.

In yet another aspect, a pipe system with integrated temperature monitoring capabilities comprises one or more plastic pipes with embedded laser-scribed graphene traces and a temperature sensing mechanism linked to the conductivity of the laser-scribed graphene traces. In an embodiment, the temperature sensing mechanism is calibrated for a range of environmental conditions and the pipe system is configured for specific temperature zone monitoring along the pipe length. The pipe system further comprises one or more of an automated response system for temperature anomalies, a central control system for comprehensive temperature management, visual indicators on the pipes for temperature readings, a fail-safe mechanism for extreme temperature conditions, and temperature sensors distributed at regular intervals along the pipe. The temperature data is preferably logged for historical analysis and the temperature sensing mechanism comprises an adjustable sensitivity. According to one or more embodiments, the pipe system is suitable for applications in both residential and industrial settings.

In yet another aspect, an electrified polyethylene or PVC pipe system comprises a series of laser-scribed graphene conductive traces integrated into the pipe's structure and a means for real-time leak detection via resistance monitoring in the conductive traces. The conductive traces are metalized to enhance conductivity. In another embodiment, the system comprises a wireless communication module connected to the conductive traces. The conductive traces also function as antennas for signal transmission. The system may include an external power source for electrifying the conductive traces. In one embodiment, the pipes are utilized in underground or underwater installations. The system may also feature an alert mechanism for detected leaks. The conductive traces are capable of detecting specific leak sizes. The system may further comprise a user interface for monitoring leak status. The conductive traces may be applied in a predefined pattern. The system may be adaptable for various pipe diameters and lengths.

In yet another aspect, a method for monitoring the structural integrity of pipe systems comprises utilizing laser-scribed graphene conductive traces on polyethylene or PVC pipes, and analyzing conductivity changes to identify potential structural issues. The method may be integrated with mobile applications for remote monitoring. Conductivity measurements are stored in a cloud database. Real-time alerts may be enabled to a control center during structural compromise. Redundancy may be incorporated in the conductive trace system for reliability. The method may be adaptable to different pipe materials beyond polyethylene and PVC.

In yet another aspect, a pipe system with integrated temperature monitoring capabilities comprises polyethylene or PVC pipes with embedded laser-scribed graphene traces and a temperature sensing mechanism linked to the conductivity of the graphene traces. The temperature sensing mechanism is calibrated for a range of environmental conditions. The system may further include an automated response system for temperature anomalies. The system may be capable of specific temperature zone monitoring along the pipe length. The system may be linked to a central control system for comprehensive temperature management. The system may include visual indicators on the pipe for temperature readings. The temperature data is logged for historical analysis. The system may comprise adjustable sensitivity for the temperature sensing mechanism. The system may include a fail-safe mechanism for extreme temperature conditions. The system may comprise temperature sensors distributed at regular intervals along the pipe. The system may be suitable for applications in both residential and industrial settings.

In yet another aspect, a water quality monitoring system comprises miniaturized sensors integrated onto the surface of conductive pipes, configured to detect parameters including pH, dissolved oxygen, turbidity, and specific contaminants. Specialized antennas are strategically placed along the pipe's surface, emitting electromagnetic waves into the pipe to detect changes in the electromagnetic field caused by the presence of water as a dielectric. Signal processing techniques are employed to analyze changes in the electromagnetic field and correlate them with water quality parameters. Wireless communication technology enables transmission of sensor data to a central monitoring station for analysis and decision-making. The miniaturized sensors are further configured to detect parameters selected from the group consisting of pH, dissolved oxygen, turbidity, and specific contaminants. Pressure sensors are configured to detect variations in pressure within the pipe. The surface-mounted sensors are further configured to monitor environmental conditions comprising temperature, humidity, and soil moisture. Strain sensors are integrated into the pipe wall for monitoring structural deformation and stress levels. Sensors are configured to detect corrosion and structural health of nearby metal pipes.

In yet another aspect, a method for detecting underground utilities utilizes an electrically conductive pipe comprising a tube structure comprising an electrically insulative wall having an interior surface and an exterior surface spaced apart by a thickness of the electrically insulative wall. The tube structure comprises a first end portion and a second end portion spaced apart longitudinally along a length thereof. A plurality of laser-scribed graphene conductive traces is integrated at least partially into the electrically insulative wall of the tube structure. The laser-scribed graphene conductive traces are integrated into a transmitting antenna. The method involves configuring the antenna wherein the laser-scribed graphene conductive traces are integrated into the tube structure to generate a unidirectional radiation pattern. The laser-scribed graphene conductive traces further comprise one or more dipole antennas configured for frequency transmission. The method involves configuring the antenna wherein the laser-scribed graphene conductive traces conform to the 2-D curved surface of the pipe. The laser-scribed graphene conductive traces are integrated to emit electromagnetic waves to create a unidirectional radiation pattern. The method involves detecting reflections of the electromagnetic waves to identify the presence and location of underground utilities. The method further involves positioning the unidirectional radiation pattern to align with the length of the electrically conductive pipe for improved detection.

In yet another aspect, an electrically conductive pipe comprises a tube structure comprising an electrically insulative wall having an interior surface and an exterior surface spaced apart by a thickness of the electrically insulative wall. The tube structure comprises a first end portion and a second end portion spaced apart longitudinally along a length thereof. A plurality of laser-scribed graphene conductive traces is integrated at least partially into the electrically insulative wall of the tube structure. The laser-scribed graphene conductive traces are integrated into the tube structure such that the laser-scribed graphene conductive traces are integrated at least one of on the interior surface of the electrically insulative wall of the tube structure, on the exterior surface of the electrically insulative wall of the tube structure, and between the interior surface and exterior surface within the electrically insulative wall of the tube structure. The laser-scribed graphene conductive traces further comprise one or more dipole antennas configured for frequency transmission. The one or more dipole antennas are configured to transmit and receive signals in the ultra-high frequency (UHF) band and in the ultra-low frequency (ULF) band. The one or more dipole antennas are configured to transmit and receive signals in the microwave band. The laser-scribed graphene conductive traces are coated with a protective material to enhance durability and resistance to environmental factors.

In yet another aspect, an electrically conductive pipe comprises a tube structure comprising an electrically insulative wall having an interior surface and an exterior surface spaced apart by a thickness of the electrically insulative wall. The tube structure comprises a first end portion and a second end portion spaced apart longitudinally along a length thereof. A plurality of laser-scribed graphene conductive traces is integrated at least partially into the electrically insulative wall of the tube structure. The laser-scribed graphene conductive traces further comprise one or more sensors for detecting environmental conditions external to the pipe.

In yet another aspect, an electrically conductive pipe comprises a tube structure comprising an electrically insulative wall having an interior surface and an exterior surface spaced apart by a thickness of the electrically insulative wall. The tube structure comprises a first end portion and a second end portion spaced apart longitudinally along a length thereof. A plurality of laser-scribed graphene conductive traces is integrated at least partially into the electrically insulative wall of the tube structure. The laser-scribed graphene conductive traces further comprise one or more actuators for adjusting the pipe's position or properties based on monitored conditions.

In yet another aspect, an electrically conductive pipe comprises a tube structure comprising an electrically insulative wall having an interior surface and an exterior surface spaced apart by a thickness of the electrically insulative wall. The tube structure comprises a first end portion and a second end portion spaced apart longitudinally along a length thereof. A plurality of laser-scribed graphene conductive traces is integrated at least partially into the electrically insulative wall of the tube structure. The laser-scribed graphene conductive traces further comprise one or more energy harvesting devices for capturing and storing energy from the environment.

In yet another aspect, an electrically conductive pipe comprises a tube structure comprising an electrically insulative wall having an interior surface and an exterior surface spaced apart by a thickness of the electrically insulative wall. The tube structure comprises a first end portion and a second end portion spaced apart longitudinally along a length thereof. A plurality of laser-scribed graphene conductive traces is integrated at least partially into the electrically insulative wall of the tube structure. The laser-scribed graphene conductive traces further comprise one or more communication devices for establishing a communication network with other pipes or external devices.

In yet another aspect, an electrically conductive pipe comprises a tube structure comprising an electrically insulative wall having an interior surface and an exterior surface spaced apart by a thickness of the electrically insulative wall. The tube structure comprises a first end portion and a second end portion spaced apart longitudinally along a length thereof. A plurality of laser-scribed graphene conductive traces is integrated at least partially into the electrically insulative wall of the tube structure. The laser-scribed graphene conductive traces further comprise one or more actuators for adjusting the pipe's shape or dimensions based on external stimuli.

In yet another aspect, an electrically conductive pipe comprises a tube structure comprising an electrically insulative wall having an interior surface and an exterior surface spaced apart by a thickness of the electrically insulative wall. The tube structure comprises a first end portion and a second end portion spaced apart longitudinally along a length thereof. A plurality of laser-scribed graphene conductive traces is integrated at least partially into the electrically insulative wall of the tube structure. A wireless communication module is configured to communicate with a remote monitoring station via a cellular network.

In yet another aspect, an electrically conductive pipe comprises a tube structure comprising an electrically insulative wall having an interior surface and an exterior surface spaced apart by a thickness of the electrically insulative wall. The tube structure comprises a first end portion and a second end portion spaced apart longitudinally along a length thereof. A plurality of laser-scribed graphene conductive traces is integrated at least partially into the electrically insulative wall of the tube structure. A wireless communication module is configured to communicate with a remote monitoring station via a mesh network.

In another aspect, an electrically conductive pipe comprises a tube structure comprising an electrically insulative wall having an interior surface and an exterior surface spaced apart by a thickness of the electrically insulative wall. The tube structure comprises a first end portion and a second end portion spaced apart longitudinally along a length thereof. A plurality of laser-scribed graphene conductive traces is integrated at least partially into the electrically insulative wall of the tube structure. A power source provides electrical power to monitoring devices and a wireless communication module.

In another aspect, electrically conductive pipe comprises a tube structure comprising an electrically insulative wall having an interior surface and an exterior surface spaced apart by a thickness of the electrically insulative wall. The tube structure comprises a first end portion and a second end portion spaced apart longitudinally along a length thereof. A plurality of laser-scribed graphene conductive traces is integrated at least partially into the electrically insulative wall of the tube structure. The electrically conductive pipe comprises a transmitter. A receiver is employed for detecting data encoded in the emitted electromagnetic waves to identify the presence and location of underground utilities.

The order of execution or performance of the operations in accordance with aspects of the present disclosure illustrated and described herein is not essential, unless otherwise specified. That is, the operations may be performed in any order, unless otherwise specified, and embodiments may include additional or fewer operations than those disclosed herein. For example, it is contemplated that executing or performing a particular operation before, contemporaneously with, or after another operation is within the scope of the present disclosure.

Not all of the depicted components illustrated or described may be required. In addition, some implementations and embodiments may include additional components. Variations in the arrangement and type of the components may be made without departing from the spirit or scope of the claims as set forth herein. Additionally, different or fewer components may be provided, and components may be combined. Alternatively, or in addition, a component may be implemented by several components.

Having described the invention in detail, it will be apparent that modifications and variations are possible without departing from the scope of the invention defined in the appended claims.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved, and other advantageous results attained.

As various changes could be made in the above products without departing from the scope of the invention, it is intended that all matter contained in the above description and shown in the accompanying drawings shall be interpreted as illustrative and not in a limiting sense.

The Abstract and Summary are provided to help the reader quickly ascertain the nature of the technical disclosure. They are submitted with the understanding that they will not be used to interpret or limit the scope or meaning of the claims. The Summary is provided to introduce a selection of concepts in simplified form that are further described in the Detailed Description. The Summary is not intended to identify key features or essential features of the claimed subject matter, nor is it intended to be used as an aid in determining the claimed subject matter.

1. An electrically conductive pipe, the electrically conductive pipe comprising:
a tube structure comprising an electrically insulative wall having an interior surface and an exterior surface spaced apart by a thickness of the electrically insulative wall, the tube structure comprising a first end portion and a second end portion spaced apart longitudinally along a length thereof; and
a plurality of laser-scribed graphene conductive traces integrated at least partially into the electrically insulative wall of the tube structure.

2. The electrically conductive pipe of claim 1, further comprising an insulating layer covering the laser-scribed graphene conductive traces.

3. The electrically conductive pipe of claim 1, wherein the laser-scribed graphene conductive traces extend along the length of the tube structure, between the first end portion and the second end portion thereof.

4. The electrically conductive pipe of claim 1, wherein the laser-scribed graphene conductive traces are integrated into the tube structure such that the laser-scribed graphene conductive traces are integrated at least one of on the interior surface of the electrically insulative wall of the tube structure, on the exterior surface of the electrically insulative wall of the tube structure, and between the interior surface and exterior surface within the electrically insulative wall of the tube structure.

5. The electrically conductive pipe of claim 4, further comprising a power source proximate at least one of the first and second end portions of the tube structure, the laser-scribed graphene conductive traces being electrically connected to the power source.

6. The electrically conductive pipe of claim 5, wherein the laser-scribed graphene conductive traces further comprise one or more split ring resonator form factors configured for remotely charging electronic devices at least one of external to the electrically conductive pipe and internal to the electrically conductive pipe.

7. The electrically conductive pipe of claim 1, wherein the laser-scribed graphene conductive traces further comprise one or more dipole antennas configured for frequency transmission.

8. The electrically conductive pipe of claim 1, further comprising one or more monitoring devices electrically connected to the laser-scribed graphene conductive traces such that the one or more monitoring devices are configured to monitor at least one of one or more electrical properties of the laser-scribed graphene conductive traces and one or more surrounding conditions of the electrically conductive pipe.

9. The electrically conductive pipe of claim 8, wherein the one or more monitoring devices are configured to monitor at least one of the one or more electrical properties of the laser-scribed graphene conductive traces and one or more surrounding conditions for at least one of leak detection of the electrically conductive pipe, structural health monitoring of the electrically conductive pipe, temperature monitoring of the electrically conductive pipe, anti-fouling of the electrically conductive pipe, heating of the electrically conductive pipe, and wireless activity of the electrically conductive pipe.

10. The electrically conductive pipe of claim 9, further comprising a wireless communication module operably connected to at least one of the one or more monitoring devices and laser-scribed graphene conductive traces, the wireless communication module being configured to communicate one or more conditions of the electrically conductive pipe based on at least one of the electrical properties of the laser-scribed graphene conductive traces and the surrounding conditions of the electrically conductive pipe.

11. The electrically conductive pipe of claim 1, wherein the electrically insulative wall of the tube structure is formed of a plastic precursor material.

12. A manufacturing method for manufacturing an electrically conductive pipe, the electrically conductive pipe comprising an interior surface and an exterior surface spaced apart by a thickness of the electrically conductive pipe, the manufacturing method comprising:
forming a tube structure from a plastic precursor material;
positioning a laser proximate the tube structure in at least one of an embedding position, interior surface position and exterior surface position;
irradiating the tube structure in a predefined trace pattern with the laser to induce precursor material reactions that convert the plastic precursor material into one or more laser-scribed graphene conductive traces for forming the electrically conductive pipe; and
wherein the laser-scribed graphene conductive traces are at least one of embedded within the electrically conductive pipe, on the interior surface of the electrically conductive pipe, and on the exterior surface of the electrically conductive pipe.

13. The method of claim 12, further comprising adjusting laser parameters of the laser to achieve a target configuration of the one or more laser-scribed graphene conductive traces.

14. The method of claim 12, further comprising covering the laser-scribed graphene conductive traces with an insulating material.

15. The method of claim 12, further comprising irradiating the tube structure in a predefined charger pattern with the laser to induce precursor material reactions that convert the plastic precursor material into one or more split ring resonator form factors configured for remotely charging electronic devices at least one of external to the electrically conductive pipe and internal to the electrically conductive pipe.

16. The method of claim 12, further comprising irradiating the tube structure in a predefined dipole antenna pattern with the laser to induce precursor material reactions that convert the plastic precursor material into one or more dipole antennas configured for frequency transmission.

17. The method of claim 12, wherein the precursor material reactions comprise at least thermal and photochemical reactions.

18. The method of claim 12, further comprising applying at least one of a graphene-based ink and paste to the predetermined trace pattern to form the one or more laser-scribed graphene conductive traces.

19. A pipe manufacturing system for manufacturing an electrically conductive pipe, the pipe manufacturing system comprising:
a pipe forming system configured to form a plastic precursor material into a tube structure comprising an electrically insulative wall having an interior surface and an exterior surface spaced apart by a pipe thickness;
a laser scribing system configured to irradiate the tube structure in a predefined trace pattern to induce precursor material reactions that convert the plastic precursor material into one or more laser-scribed graphene conductive traces that are at least one of embedded within the electrically insulative wall of the tube structure, on the interior surface of the electrically insulative wall of the tube structure, and on the exterior surface of the electrically insulative wall of the tube structure;
an electroplating system configured to apply a layer of electrodeposited material to the one or more laser-scribed graphene conductive traces; and
an insulating material coating system configured to apply insulating material to the one or more laser-scribed graphene conductive traces.

20. The pipe manufacturing system of claim 19, further comprising a deposition system configured to deposit at least one of graphene-based ink and paste into the one or more laser-scribed graphene conductive traces.

21. The pipe manufacturing system of claim 19, wherein the laser scribing system is configured to move along at least one of a length and circumference of the tube structure.

22. The electrically conductive pipe of claim 1, configured for use in at least one of leak detection, structural health monitoring, temperature monitoring, anti-fouling, heating, wireless communication, wireless charging, children's play equipment, moisture sensing, liquid transport system monitoring, pest deterring, fault detection, in-pipe liquid freezing prevention, air pocket formation detection, pressure sensing, piping system maintenance, utility mapping, flow rate monitoring, and corrosion detection.
